(19) United States
(12) Patent Application Publication
(10) Pub. No.: US 2025/0373376 A1
(43) Pub. Date: Dec. 4, 2025

(54) NON-ZERO COEFFICIENT SELECTION AND STRONGEST COEFFICIENT INDICATOR FOR COHERENT JOINT TRANSMISSION CHANNEL STATE INFORMATION

(71) Applicant: QUALCOMM Incorporated, San Diego, CA (US)

(72) Inventors: Hao XU, Beijing (CN); Wei XI, Beijing (CN); Liangming WU, Beijing (CN); Chao WEI, Beijing (CN); Chenxi HAO, Beijing (CN); Min HUANG, Beijing (CN); Jing DAI, Beijing (CN)

(21) Appl. No.: 18/876,589

(22) PCT Filed: Jul. 22, 2022
(86) PCT No.: PCT/CN2022/107263

§ 371 Date: Dec. 18, 2024

(51) Int. Cl. H04L 5/00; H04W 72/0453; H04W 72/21

(52) U.S. Cl. CPC H04L 5/0035; H04W 72/0453; H04W 72/21

(57) ABSTRACT

Methods, systems, and devices for wireless communications are described. A user equipment (UE) may receive channel state information (CSI) reference signals (CSI-RS) s from multiple transmission and reception points (TRP) s and may perform measurements on the CSI-RSs to identify suitable configurations for communicating with the TRPs. The UE may also transmit a CSI report to a network entity such that the network entity may identify suitable configurations at the TRPs for communicating with the UE. The CSI report may include a non-zero coefficient (NZC) bitmap based on measurements of the CSI-RSs using frequency domain (FD) and spatial domain (SD) bases associated with each of the TRPs. Described techniques provide for block based NZC bitmap reporting which may take advantage of the partial overlap in FD bases for different TRPs to decrease NZC bitmap size.

### CROSS REFERENCE

The present application is a 371 national phase filing of International PCT Application No. PCT/CN2022/107263 by XU et al., entitled “NON-ZERO COEFFICIENT SELECTION AND STRONGEST COEFFICIENT INDICATOR FOR COHERENT JOINT TRANSMISSION CHANNEL STATE INFORMATION,” filed Jul. 22, 2022, which is assigned to the assignee hereof, and which is expressly incorporated by reference in its entirety herein.

### FIELD OF TECHNOLOGY

The following relates to wireless communications, including non-zero coefficient selection and strongest coefficient indicator for coherent joint transmission channel state information.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support non-zero coefficient selection and strongest coefficient indicator (SCI) for coherent joint transmission channel state information. A user equipment (UE) may receive channel state information (CSI) reference signals (CSI-RS) s from multiple transmission and reception points (TRP) s and may perform measurements on the CSI-RSs to identify suitable configurations for communicating with the TRPs. The UE may also transmit a CSI report to a network entity such that the network entity may identify suitable configurations at the TRPs for communicating with the UE. The CSI report may include a non-zero coefficient (NZC) bitmap based on measurements of the CSI-RSs using frequency domain (FD) and spatial domain (SD) bases associated with each of the TRPs. Described techniques provide for block based NZC bitmap reporting which may take advantage of the overlap in FD bases for different TRPs to decrease NZC bitmap size. Because of a time delay difference between reception at the UE of CSI-RSs from a first TRP and a second TRP (e.g., due to location differences in the TRPs), the FD basis selection for the first TRP and the second TRP may be reported separately, thereby decreasing the size of the NZC bitmap by exploiting the overlap in FD bases between the first TRP and the second TRP. For the UE and network entity to identify a NZC bitmap format, the UE and the network entity should both know the number of selected FD bases and SD bases per TRP reported. Accordingly, the control signaling indicating the multi-TRP configuration for the UE may indicate the number of FD and/or SD bases per TRP, or the UE may indicate in the uplink control information (UCI) conveying the NZC bitmap the number of number of FD and/or SD bases per TRP.

A method for wireless communications at a UE is described. The method may include receiving control signaling indicating a multi-TRP configuration for the UE to use to communicate with a network entity via a first TRP and a second TRP associated with the network entity, receiving CSI-RSs from the first TRP and the second TRP according to the multi-TRP configuration, and transmitting, to the network entity, an UCI message including a NZC bitmap that is based on measurements of the CSI-RSs, where a size in quantity of bits of the NZC bitmap is based on a quantity of FD bases and a quantity of SD bases associated with the first TRP and the second TRP, where the FD bases associated with the first TRP at least partially overlap the FD bases associated with the second TRP.

An apparatus for wireless communications is described. The apparatus may include a memory, a transceiver, and at least one processor of a UE, the at least one processor coupled with the memory and the transceiver. The at least one processor may be configured to receive control signaling indicating a multi-TRP configuration for the UE to use to communicate with a network entity via a first TRP and a second TRP associated with the network entity, receive CSI-RSs from the first TRP and the second TRP according to the multi-TRP configuration, and transmit, to the network entity, an UCI message including a NZC bitmap that is based on measurements of the CSI-RSs, where a size in quantity of bits of the NZC bitmap is based on a quantity of FD bases and a quantity of SD bases associated with the first TRP and the second TRP, where the FD bases associated with the first TRP at least partially overlap the FD bases associated with the second TRP.

Another apparatus for wireless communications at a UE is described. The apparatus may include means for receiving control signaling indicating a multi-TRP configuration for the UE to use to communicate with a network entity via a first TRP and a second TRP associated with the network entity, means for receiving CSI-RSs from the first TRP and the second TRP according to the multi-TRP configuration, and means for transmitting, to the network entity, an UCI message including a NZC bitmap that is based on measurements of the CSI-RSs, where a size in quantity of bits of the NZC bitmap is based on a quantity of FD bases and a quantity of SD bases associated with the first TRP and the second TRP, where the FD bases associated with the first TRP at least partially overlap the FD bases associated with the second TRP.

A non-transitory computer-readable medium storing code for wireless communications at a UE is described. The code may include instructions executable by a processor to receive control signaling indicating a multi-TRP configuration for the UE to use to communicate with a network entity via a first TRP and a second TRP associated with the network entity, receive CSI-RSs from the first TRP and the second TRP according to the multi-TRP configuration, and transmit, to the network entity, an UCI message including a NZC bitmap that is based on measurements of the CSI-RSs, where a size in quantity of bits of the NZC bitmap is based on a quantity of FD bases and a quantity of SD bases associated with the first TRP and the second TRP, where the FD bases associated with the first TRP at least partially overlap the FD bases associated with the second TRP.

In some examples of the method, apparatuses, and non-transitory computer-readable medium described herein, transmitting the UCI message may include operations, features, means, or instructions for transmitting the UCI message including one or more fields indicating a first quantity of FD bases associated with the first TRP and a second quantity of FD bases associated with the second TRP, where the quantity of FD bases may be based on the first quantity and the second quantity.

In some examples of the method, apparatuses, and non-transitory computer-readable medium described herein, transmitting the UCI message may include operations, features, means, or instructions for transmitting the UCI message including one or more fields indicating a selection of the first TRP and the second TRP from a set of multiple TRPs, where the control signaling indicates the multi-TRP configuration for the UE to use to communicate with the network entity including the set of multiple TRPs.

In some examples of the method, apparatuses, and non-transitory computer-readable medium described herein, a quantity of FD bases per TRP may be inversely related to a quantity of TRPs selected in the UCI message.

In some examples of the method, apparatuses, and non-transitory computer-readable medium described herein, a quantity of FD bases per TRP may be inversely related to a quantity of layers reported in the UCI message.

In some examples of the method, apparatuses, and non-transitory computer-readable medium described herein, transmitting the UCI message may include operations, features, means, or instructions for transmitting the UCI message including one or more fields indicating a first quantity of SD bases associated with the first TRP and a second quantity of SD bases associated with the second TRP, where the quantity of SD bases may be based on the first quantity and the second quantity.

In some examples of the method, apparatuses, and non-transitory computer-readable medium described herein, receiving the control signaling may include operations, features, means, or instructions for receiving an indication of a first quantity of FD bases associated with the first TRP and a second quantity of FD bases associated with the second TRP, where the quantity of FD bases may be based on the first quantity and the second quantity.

In some examples of the method, apparatuses, and non-transitory computer-readable medium described herein, receiving the control signaling may include operations, features, means, or instructions for receiving an indication of a first quantity of SD bases associated with the first TRP and a second quantity of SD bases associated with the second TRP, where the quantity of SD bases may be based on the first quantity and the second quantity.

In some examples of the method, apparatuses, and non-transitory computer-readable medium described herein, transmitting the UCI message may include operations, features, means, or instructions for transmitting the UCI message including a set of fields indicating a layer-specific FD basis selection of a per-TRP basis.

In some examples of the method, apparatuses, and non-transitory computer-readable medium described herein, receiving the control signaling may include operations, features, means, or instructions for receiving the control signaling indicating the first TRP and the second TRP share a same layer-specific FD basis selection.

In some examples of the method, apparatuses, and non-transitory computer-readable medium described herein, transmitting the UCI message may include operations, features, means, or instructions for transmitting a first delta amplitude associated with the first TRP and a second delta amplitude associated with the second TRP, where the first delta amplitude and the second delta amplitude may be over a strongest coefficient.

In some examples of the method, apparatuses, and non-transitory computer-readable medium described herein, transmitting the UCI message may include operations, features, means, or instructions for transmitting the UCI message including a set of fields indicating a layer-common SD basis selection on a per TRP basis.

In some examples of the method, apparatuses, and non-transitory computer-readable medium described herein, receiving the control signaling may include operations, features, means, or instructions for receiving the control signaling indicating the first TRP and the second TRP share a same layer-common SD basis selection.

In some examples of the method, apparatuses, and non-transitory computer-readable medium described herein, a first quantity of FD bases associated with the first TRP may be the same as a second quantity of FD bases associated with the second TRP.

In some examples of the method, apparatuses, and non-transitory computer-readable medium described herein, transmitting the UCI message may include operations, features, means, or instructions for transmitting the UCI message including a field indicating a selection of one of the first TRP or the second TRP from a set of multiple TRPs, where the control signaling indicates the multi-TRP configuration for the UE to use to communicate with the network entity including the set of multiple TRPs, and where the selection of one of the first TRP or the second TRP includes a selection of both the first TRP and the second TRP.

In some examples of the method, apparatuses, and non-transitory computer-readable medium described herein, transmitting the UCI message may include operations, features, means, or instructions for transmitting a single delta amplitude associated with the first TRP and the second TRP, where the single delta amplitude may be over a strongest coefficient.

A method for wireless communications at a network entity is described. The method may include outputting, to a UE, control signaling indicating a multi-TRP configuration for the UE to use to communicate with the network entity via a first TRP and a second TRP associated with the network entity, outputting, via the first TRP and the second TRP, CSI-RSs according to the multi-TRP configuration, and obtaining, from the UE and in response to the CSI-RSs, an UCI message including a NZC bitmap, where a size in quantity of bits of the NZC bitmap is based on a quantity of FD bases and a quantity of SD bases associated with the first TRP and the second TRP, where the FD bases associated with the first TRP at least partially overlap the FD bases associated with the second TRP.

An apparatus for wireless communications is described. The apparatus may include a memory and at least one processor of a network entity, the at least one processor coupled with the memory. The at least one processor may be configured to output, to a UE, control signaling indicating a multi-TRP configuration for the UE to use to communicate with the network entity via a first TRP and a second TRP associated with the network entity, output, via the first TRP and the second TRP, CSI-RSs according to the multi-TRP configuration, and obtain, from the UE and in response to the CSI-RSs, an UCI message including a NZC bitmap, where a size in quantity of bits of the NZC bitmap is based on a quantity of FD bases and a quantity of SD bases associated with the first TRP and the second TRP, where the FD bases associated with the first TRP at least partially overlap the FD bases associated with the second TRP.

Another apparatus for wireless communications at a network entity is described. The apparatus may include means for outputting, to a UE, control signaling indicating a multi-TRP configuration for the UE to use to communicate with the network entity via a first TRP and a second TRP associated with the network entity, means for outputting, via the first TRP and the second TRP, CSI-RSs according to the multi-TRP configuration, and means for obtaining, from the UE and in response to the CSI-RSs, an UCI message including a NZC bitmap, where a size in quantity of bits of the NZC bitmap is based on a quantity of FD bases and a quantity of SD bases associated with the first TRP and the second TRP, where the FD bases associated with the first TRP at least partially overlap the FD bases associated with the second TRP.

A non-transitory computer-readable medium storing code for wireless communications at a network entity is described. The code may include instructions executable by a processor to output, to a UE, control signaling indicating a multi-TRP configuration for the UE to use to communicate with the network entity via a first TRP and a second TRP associated with the network entity, output, via the first TRP and the second TRP, CSI-RSs according to the multi-TRP configuration, and obtain, from the UE and in response to the CSI-RSs, an UCI message including a NZC bitmap, where a size in quantity of bits of the NZC bitmap is based on a quantity of FD bases and a quantity of SD bases associated with the first TRP and the second TRP, where the FD bases associated with the first TRP at least partially overlap the FD bases associated with the second TRP.

In some examples of the method, apparatuses, and non-transitory computer-readable medium described herein, obtaining the UCI message may include operations, features, means, or instructions for obtaining the UCI message including one or more fields indicating a selection of the first TRP and the second TRP from a set of multiple TRPs, where the control signaling indicates the multi-TRP configuration for the UE to use to communicate with the network entity including the set of multiple TRPs.

In some examples of the method, apparatuses, and non-transitory computer-readable medium described herein, a quantity of FD bases per TRP may be inversely related to a quantity of layers reported in the UCI message.

In some examples of the method, apparatuses, and non-transitory computer-readable medium described herein, obtaining the UCI message may include operations, features, means, or instructions for obtaining the UCI message including one or more fields indicating a first quantity of SD bases associated with the first TRP and a second quantity of SD bases associated with the second TRP, where the quantity of SD bases may be based on the first quantity and the second quantity.

In some examples of the method, apparatuses, and non-transitory computer-readable medium described herein, outputting the control signaling may include operations, features, means, or instructions for outputting an indication of a first quantity of FD bases associated with the first TRP and a second quantity of FD bases associated with the second TRP, where the quantity of FD bases may be based on the first quantity and the second quantity.

In some examples of the method, apparatuses, and non-transitory computer-readable medium described herein, outputting the control signaling may include operations, features, means, or instructions for outputting an indication of a first quantity of SD bases associated with the first TRP and a second quantity of SD bases associated with the second TRP, where the quantity of FD bases may be based on the first quantity and the second quantity.

In some examples of the method, apparatuses, and non-transitory computer-readable medium described herein, obtaining the UCI message may include operations, features, means, or instructions for obtaining the UCI message including a set of fields indicating a layer-specific FD basis selection of a per-TRP basis.

In some examples of the method, apparatuses, and non-transitory computer-readable medium described herein, outputting the UCI message may include operations, features, means, or instructions for outputting the UCI message including a set of fields indicating a layer-common SD basis selection on a per TRP basis.

### BRIEF DESCRIPTION OF THE DRAWINGS

FIG. 1 illustrates an example of a wireless communications system that supports non-zero coefficient (NZC) selection and strongest coefficient indicator (SCI) for coherent joint transmission (CJT) channel state information (CSI) in accordance with one or more aspects of the present disclosure.

FIG. 2 illustrates an example of a network architecture that supports NZC selection and SCI for CJT CSI in accordance with one or more aspects of the present disclosure.

FIG. 3 illustrates an example of non-CJTs that support NZC selection and SCI for CJT CSI in accordance with one or more aspects of the present disclosure.

FIG. 4 illustrates an example of a non-CJTs that support NZC selection and SCI for CJT CSI in accordance with one or more aspects of the present disclosure.

FIG. 5 illustrates an example of precoding matrices indicated in a CSI report for multiple layers that support NZC selection and SCI for CJT CSI in accordance with one or more aspects of the present disclosure.

FIG. 6 illustrates an example of orientations of different antenna panels used for CJTs that supports NZC selection and SCI for CJT CSI in accordance with one or more aspects of the present disclosure.

FIG. 7 illustrates an example of a selection of spatial and frequency bases that supports NZC selection and SCI for CJT CSI in accordance with one or more aspects of the present disclosure.

FIG. 8 illustrates an example of a frequency domain basis selection method that supports NZC selection and SCI for CJT CSI in accordance with one or more aspects of the present disclosure.

FIG. 9 illustrates an example of a selection of spatial and frequency bases that supports NZC selection and SCI for CJT CSI in accordance with one or more aspects of the present disclosure.

FIG. 10 illustrates an example of a UCI format that supports NZC selection and SCI for CJT CSI in accordance with one or more aspects of the present disclosure.

FIG. 11 illustrates an example of a process flow that supports NZC selection and SCI for CJT CSI in accordance with one or more aspects of the present disclosure.

FIGS. 12 and 13 show block diagrams of devices that support NZC selection and SCI for CJT CSI in accordance with one or more aspects of the present disclosure.

FIG. 14 shows a block diagram of a communications manager that supports NZC selection and SCI for CJT CSI in accordance with one or more aspects of the present disclosure.

FIG. 15 shows a diagram of a system including a device that supports NZC selection and SCI for CJT CSI in accordance with one or more aspects of the present disclosure.

FIGS. 16 and 17 show block diagrams of devices that support NZC selection and SCI for CJT CSI in accordance with one or more aspects of the present disclosure.

FIG. 18 shows a block diagram of a communications manager that supports NZC selection and SCI for CJT CSI in accordance with one or more aspects of the present disclosure.

FIG. 19 shows a diagram of a system including a device that supports NZC selection and SCI for CJT CSI in accordance with one or more aspects of the present disclosure.

FIGS. 20 through 23 show flowcharts illustrating methods that support NZC selection and SCI for CJT CSI in accordance with one or more aspects of the present disclosure.

### DETAILED DESCRIPTION

In some wireless communications systems, a user equipment (UE) may communicate with multiple transmission reception points (TRP) s to improve throughput or improve the reliability of communications. For instance, when operating in a multi-TRP operation mode, the UE may simultaneously receive different downlink data from multiple TRPs, resulting in improved throughput, or the UE may receive the same downlink data from multiple TRPs, resulting in improved reliability (e.g., a higher chance that the data is received by the UE). The network may implement coherent joint transmissions (CJT) s, which refers to transmissions including data that is jointly precoded at different TRPs or precoded separately at different TRPs with controlled phases and coefficients, which may reduce a number of layers used for transmission from multiple TRPs. In such systems, the TRPs may transmit channel state information (CSI) reference signals (CSI-RS) s to the UE, and the UE may perform measurements on the CSI-RSs to identify suitable configurations for communicating with the TRPs. The UE may also transmit a CSI report to a network entity such that the network entity may identify suitable configurations at the TRPs for communicating with the UE. The CSI report may include a non-zero coefficient (NZC) bitmap based on measurements of the CSI-RSs using frequency domain (FD) and spatial domain (SD) bases associated with each of the TRPs. Some TRPs may share some FD bases. Reporting the NZC bitmap without accounting for the overlap in the FD bases may increase communications overhead.

Aspects of the disclosure related to block based NZC bitmap reporting which may take advantage of the overlap in FD bases for different TRPs to decrease NZC bitmap size. Because of a time delay difference between reception at the UE of CSI-RSs from a first TRP and a second TRP (e.g., due to location differences in the TRPs), the FD basis selection for the first TRP and the second TRP may be reported separately, thereby decreasing the size of the NZC bitmap by exploiting the overlap in FD bases between the first TRP and the second TRP. For the UE and network entity to identify a NZC bitmap format, the UE and the network entity should both know the number of selected FD bases and SD bases per TRP reported. Accordingly, the control signaling indicating the multi-TRP configuration for the UE may indicate the number of FD and/or SD bases per TRP, or the UE may indicate in the uplink control information (UCI) conveying the NZC bitmap the number of number of FD and/or SD bases per TRP.

Aspects of the disclosure are initially described in the context of wireless communications systems. Examples of processes and signaling exchanges that support NZC selection and strongest coefficient indicator (SCI) for CJT CSI are then described. Aspects of the disclosure are further illustrated by and described with reference to apparatus diagrams, system diagrams, and flowcharts that relate to NZC selection and SCI for CJT CSI.

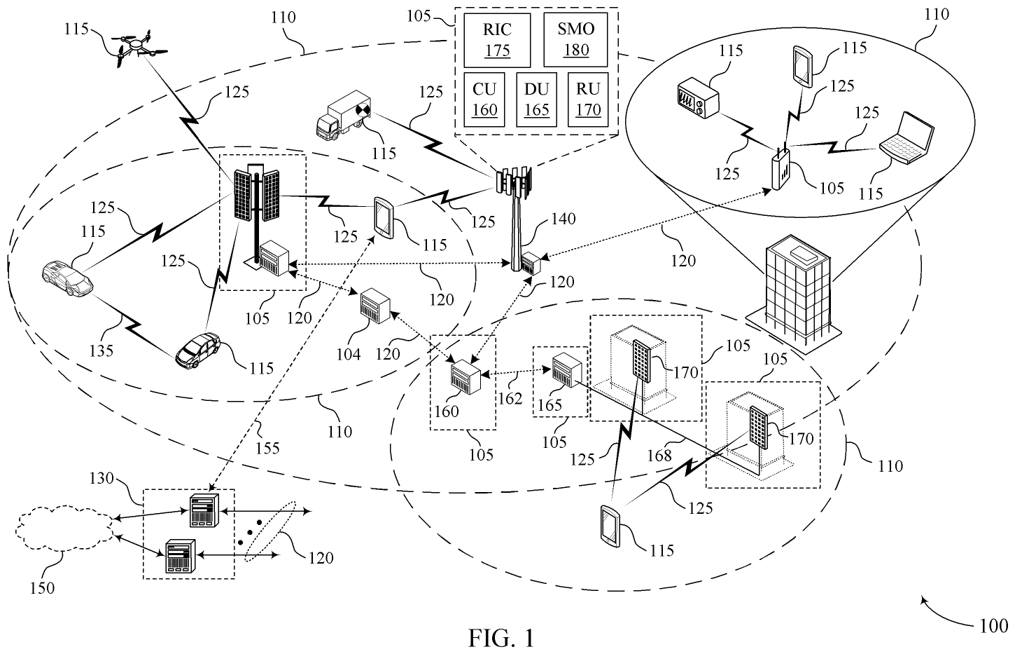

FIG. 1 illustrates an example of a wireless communications system 100 that supports NZC selection and SCI for CJT CSI in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support NZC selection and SCI for CJT CSI as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” “outputting, ” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Ts=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a CSI reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In the wireless communications system 100, a UE 115 may communicate with multiple TRPs to improve throughput or improve the reliability of communications. For instance, when operating in a multi-TRP operation mode, the UE 115 may simultaneously receive different downlink data from multiple TRPs, resulting in improved throughput, or the UE 115 may receive the same downlink data from multiple TRPs, resulting in improved reliability (e.g., a higher chance that the data is received by the UE 115). The network may implement coherent joint transmissions (CJTs), which refers to transmissions including data that is jointly precoded at different TRPs or precoded separately at different TRPs with controlled phases and coefficients, which may reduce a number of layers used for transmission from multiple TRPs. CJT Enhanced Type-II CSI for CJT may enable a larger number of ports in low frequency bands with distributed TRPs or antenna panels. For example, in some cases, for a single TRP or antenna panel with 32 ports, the antenna size may be too large for practical deployment.

In systems implementing CJT, the TRPs may transmit CSI-RSs) to the UE 115, and the UE 115 may perform measurements on the CSI-RSs to identify suitable configurations for communicating with the TRPs. The UE 115 may also transmit a CSI report to a network entity 105 such that the network entity 105 may identify suitable configurations at the TRPs for communicating with the UE 115. The CSI report may include a NZC bitmap based on measurements of the CSI-RSs using FD and SD bases associated with each of the TRPs. Some TRPs may share some FD bases. Reporting the NZC bitmap without accounting for the overlap in the FD bases may increase communications overhead.

Block based NZC bitmap reporting may take advantage of the overlap in FD bases for different TRPs to decrease NZC bitmap size. Because of a time delay difference between reception at the UE 115 of CSI-RSs from a first TRP and a second TRP (e.g., due to location differences in the TRPs), the FD basis selection for the first TRP and the second TRP may be reported separately, thereby decreasing the size of the NZC bitmap by exploiting the overlap in FD bases between the first TRP and the second TRP. For the UE 115 and network entity 105 to identify a NZC bitmap format, the UE 115 and the network entity 105 should both know the number of selected FD bases and SD bases per TRP reported. Accordingly, the control signaling indicating the multi-TRP configuration for the UE 115 may indicate the number of FD and/or SD bases per TRP, or the UE 115 may indicate in the UCI conveying the NZC bitmap the number of number of FD and/or SD bases per TRP.

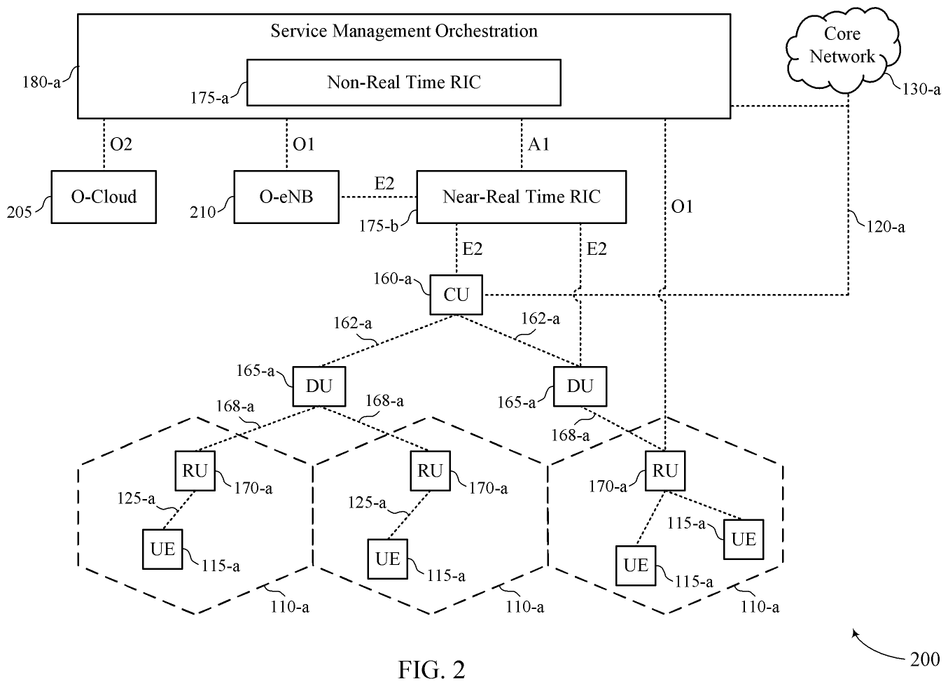

FIG. 2 illustrates an example of a network architecture 200 (e.g., a disaggregated base station architecture, a disaggregated RAN architecture) that supports NZC selection and SCI for CJT CSI in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via 01) or via generation of RAN management policies (e.g., A1 policies).

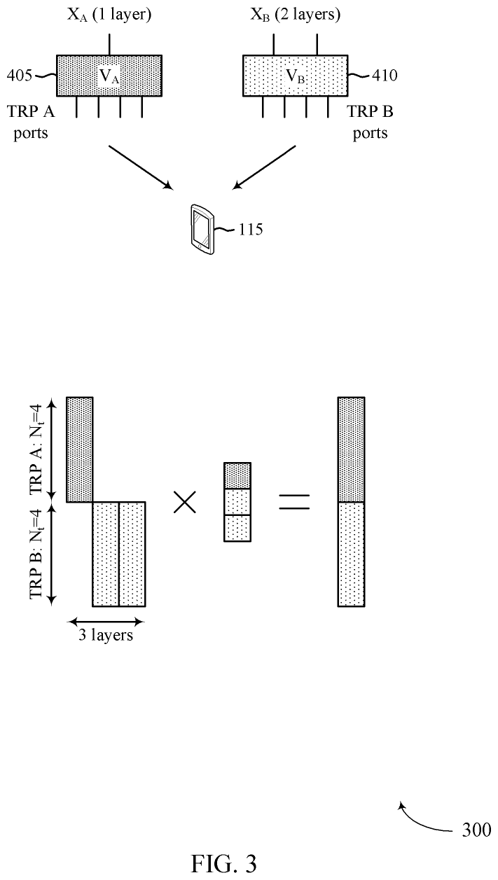

FIG. 3 illustrates an example of a non-CJTs 300 that support NZC selection and SCI for CJT CSI in accordance with one or more aspects of the present disclosure. Non-coherent joint transmissions may be based on spatial division multiplexing (SDM), and data may be precoded separately at different TRPs. A first TRP 305 may precode data X_{A} using a precoder V_{A}, and a second TRP 310 may precode data X_{B} using a precoder V_{B}. A precoder V

$$( {N}_{t}^{T R P} \times {RI}^{T R P} )$$

used for precoding a data transmission at a TRP may be based on a number of transmit antennas at the TRP to be used for the data transmission and a rank of the data transmission (e.g., V_{A}: 4×1, V_{B}: 4×2). Further, the data X (RI^{TRP}×1) to be precoded for the data transmission from a TRP may be mapped to different layers based on a rank of the data transmission (e.g., X_{A}: 1×1, X_{B}: 2×1). Thus, the precoded data transmission from the first TRP 205 and the second TRP 305 may be given by equation 1.

$$[ \begin{matrix}{V}_{A} & 0 \\ 0 & {V}_{B}\end{matrix} ] [ \begin{matrix}{X}_{A} \\ {X}_{B}\end{matrix} ] = [ \begin{matrix}{V}_{A} {X}_{A} \\ {V}_{B} {X}_{B}\end{matrix} ] \qquad ( 1 )$$

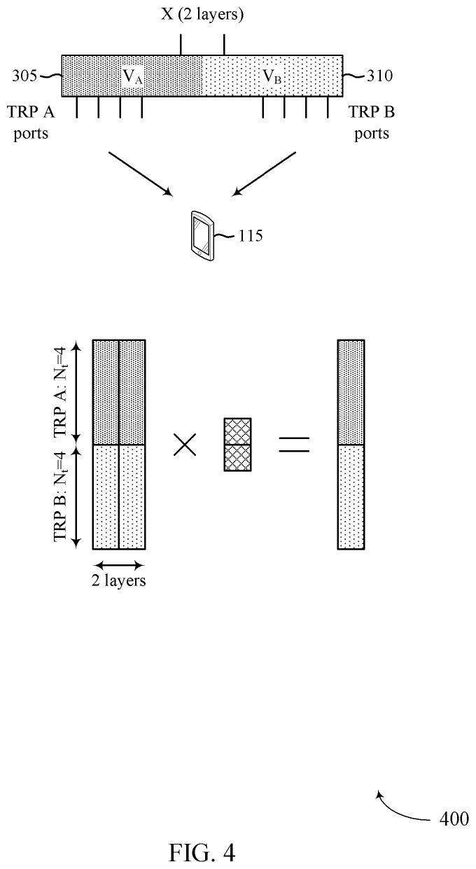

FIG. 4 illustrates an example of a CJTs 400 that supports NZC selection and SCI for CJT CSI in accordance with one or more aspects of the present disclosure. Coherent joint transmissions may refer to transmissions including data that is jointly precoded at different TRPs or precoded separately at different TRPs with controlled phases and coefficients.

In the example of the CJTs 400, data may be jointly precoded at different TRPs (e.g., data is precoded in a fully, joint way). A first TRP 405 may precode data X using a precoder V_{A}, and a second TRP 410 may precode the data X using a precoder V_{B}. A precoder V

$$( {N}_{t}^{T R P} \times {RI}^{joint} )$$

used for precoding a data transmission at a TRP may be based on a number of transmit antennas at the TRP to be used for the data transmission and a rank of the data transmission (e.g., V_{A}: 4×2, V_{B}: 4×2). Further, the data X (RI^{joint}×1) to be precoded for the data transmission from the first TRP 405 and the second TRP 410 may be mapped to different layers based on a rank of the data transmission (e.g., X_{A}: 2×1). Thus, the precoded data transmission from the first TRP 305 and the second TRP 310 may be given by equation 2.

$$[ \begin{matrix}{V}_{A} \\ {V}_{B}\end{matrix} ] \cdot X = [ \begin{matrix}{V}_{A} X \\ {V}_{B} X\end{matrix} ] \qquad ( 2 )$$

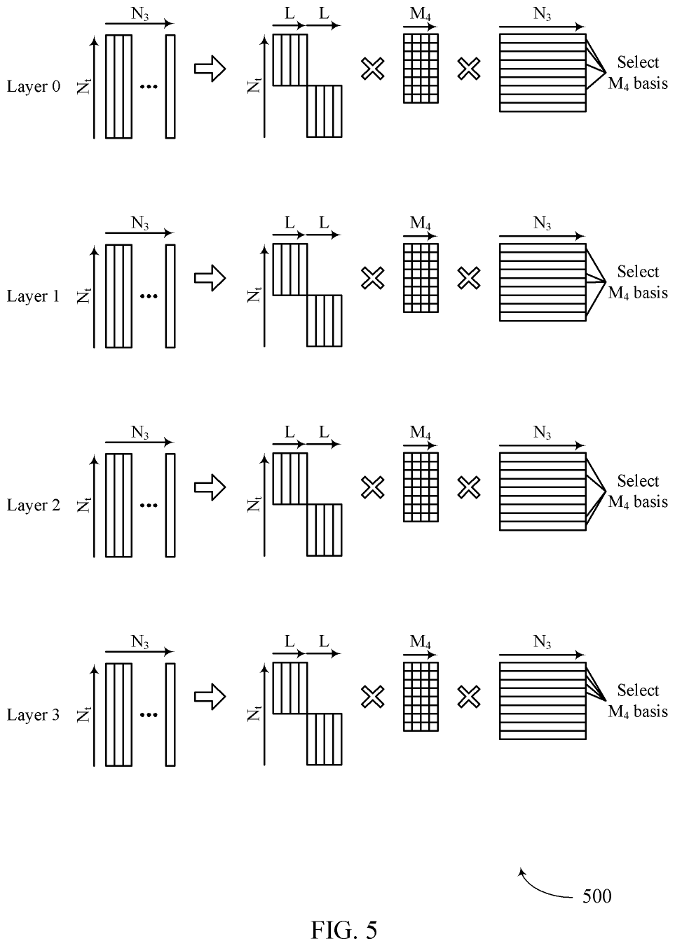

FIG. 5 illustrates an example of precoding matrices indicated in a CSI report for multiple layers 500 that supports NZC selection and SCI for CJT CSI in accordance with one or more aspects of the present disclosure. A UE 115 may indicate precoding matrices for each of the multiple layers in the CSI report, and the CSI report may support up to a rank of four (i.e., four layers). For each layer, the precoder across a number of N₃ precoding matrix indicator (PMI) subbands may be a Nₜ×N₃ matrix W

$$( e . g . , W = {W}_{1} \times {\tilde{W}}_{2} \times {W}_{f}^{H} ) .$$

A number of PMI subbands N₃ may be determined by a number of channel quality indicator (CQI) subbands and a number of PMI subbands per CQI subband (e.g., R={1,2}). In some cases, a number of CQI subbands may be determined by a high layer parameter (e.g., csi-ReportingBand), and a number of PMI subbands per CQI subband may also be configured (e.g., by a parameter numberOfPMISubbandsPerCQISubband). For R=1, N₃ may be equal to a number of CQI subbands (e.g., with possible values {1, 2, . . . , 19}). For R=2, the possible values of N₃ may be {1, 2, . . . , 37}. In some cases, a PMI subband size may be finer than a CQI subband size (e.g., half), which may be better than the PMI subband size being equal to the CQI subband size. For an edge CQI subband, if a number of resource blocks is less than or equal to a nominal CQI subband size divided by two, a UE 115 may report one PMI. Alternatively, for an edge CQI subband, if a number of resource blocks is greater than a CSI subband size divided by two, a UE 115 may report two PMIs. For other CQI subbands, a UE 115 may report two PMIs.

SD bases W₁ (e.g., discrete Fourier transform (DFT) bases) in the matrix may be a Nₜ×2L matrix, where Nₜ may refer to a number of transmit antennas and L may refer to a number of beams. W₁ may be layer-common, Nₜ may be RRC configured (e.g., Nₜ=2N₁O₁N₂O₂, with O₁ and O₂ oversampling), and L may be RRC configured (e.g., L={2,4,6}).

FD bases W_{f} (e.g., DFT bases) may be an M×N₃ matrix, where M may refer to a number or quantity of FD bases. may be layer-specific, M may be rank-pair specific (e.g., M₁=M₂ for rank={1,2}, and M₃=M₄ for rank={3,4}, where M₁ or M₃ is RRC configured).

Coefficients \tilde{W}₂ may be a 2L×M matrix and may be layer-specific. For each layer, a UE 115 may report up to K₀ non-zero coefficients (NZCs), where K₀ is RRC configured. Across all layers, the UE 115 may report up to 2K₀ non-zero coefficients. Unreported coefficients may be set to zeros, and the UE 115 may quantize the \tilde{W}₂ coefficients before reporting.

For a layer l, a UE 115 may quantize NZCs of \tilde{W}_{2,l} (e.g., layer-independent quantization). The NZCs may be reported for two different polarizations for transmissions from a TRP. Equation 3 shows an example of a matrix of coefficients \tilde{W}₂ (e.g., quantization of \tilde{W}₂ for Type-II CSI).

$$[ \begin{matrix}{p}_{ref} {p}_{0 , 0} {e}^{j {ϕ}_{0 , 0}} & {p}_{ref} {p}_{0 , 1} {e}^{j {ϕ}_{0 , 1}} & … & {p}_{ref} {p}_{0 , M - 1} {e}^{j {ϕ}_{0 , M - 1}} \\ {p}_{ref} {p}_{1 , 0} {e}^{j {ϕ}_{1 , 0}} & {p}_{ref} {p}_{1 , 1} {e}^{j {ϕ}_{1 , 1}} & … & {p}_{ref} {p}_{1 , M - 1} {e}^{j {ϕ}_{1 , M - 1}} \\ ⋮ & ⋮ & & ⋱ ⋮ \\ {p}_{ref} {p}_{L - 1 , 0} {e}^{j {ϕ}_{L - 1 , 0}} & {p}_{ref} {p}_{L - 1 , 1} {e}^{j {ϕ}_{L - 1 , 1}} & … & {p}_{ref} {p}_{L - 1 , M - 1} {e}^{j {ϕ}_{L - 1 , M - 1}} \\ 1 & {p}_{L , 1} {e}^{j {ϕ}_{L , 1}} & … & {p}_{L , M - 1} {e}^{j {ϕ}_{L , M - 1}} \\ {p}_{L + 1 , 0} {e}^{j {ϕ}_{L + 1 , 0}} & {p}_{L + 1 , 1} {e}^{j {ϕ}_{L + 1 , 1}} & … & {p}_{L + 1 , M - 1} {e}^{j {ϕ}_{L + 1 , M - 1}} \\ ⋮ & ⋮ & & ⋱ ⋮ \\ {p}_{2 L - 1 , 0} {e}^{j {ϕ}_{2 L - 1 , 0}} & {p}_{2 L - 1 , 1} {e}^{j {ϕ}_{2 L - 1 , 1}} & … & {p}_{2 L - 1 , M - 1} {e}^{j {ϕ}_{2 L - 1 , M - 1}}\end{matrix} ] \qquad ( 3 )$$

At a first step, the UE 115 may report an index of a strongest coefficient (e.g., NZC), and the strongest coefficient may be used as a reference for a stronger polarization. The stronger polarization may refer to a polarization associated with the strongest coefficient, and the weaker polarization may be the other polarization. If the strongest coefficient is one, the UE 115 may not quantize the coefficient. For example, the strongest coefficient in Equation 3 is the “1” in the first column. The strongest coefficient may be used as a reference for the stronger polarization. The UE 115 may also report a reference power for a weaker polarization. At a second step, the UE 115 may quantize the reference power for the weaker polarization with four bits from 0 dB with a −1.5 dB (in power) step size. The UE 115 may also report a differential amplitude for each coefficient. The UE 115 may quantize the differential amplitude with three bits from 0 dB with a −3 dB (in power) step size. The UE 115 may also report a phase quantization for each coefficient. The UE 115 may quantize the phase with a 16 phase shift keying (PSK) alphabet.

The number of SD bases, FD basis, and NZCs to be reported by a UE 115 may be given by Table 1.

TABLE 1
Number of SD bases, FD bases, and NZCs

p_{ν}

| paramCombination | L | ν ∈ {1, 2} | ν ∈ {3, 4} | β |
|---|---|---|---|---|
| 1 | 2 | ¼ | ⅛ | ¼ |
| 2 | 2 | ¼ | ⅛ | ½ |
| 3 | 4 | ¼ | ⅛ | ¼ |
| 4 | 4 | ¼ | ⅛ | ½ |
| 5 | 4 | ¼ | ¼ | ¾ |
| 6 | 4 | ¼ | ¼ | ½ |
| 7 | 6 | ¼ | — | ½ |
| 8 | 6 | ¼ | — | ¾ |

For a number of spatial domain bases, L={2, 4, 6}. For a number of FD bases,

$${M}_{1} = {M}_{2} = ⌈ {p}_{1} \times \frac{{N}_{3}}{R} ⌉ and {M}_{3} = {M}_{4} = ⌈ {p}_{3} \times \frac{{N}_{3}}{R} ⌉ .$$

For a number of NZCs, K₀=┌β×2KM₁┐. A UE 115 may receive RRC signaling to configure a (e.g., 1 out of 8) combination of L, p₁, p₃, β.

As the number of TRPs with which a UE 115 may be configured to communicate increases, the overhead of CSI reporting also increases (e.g., since the UE 115 may report SD bases, FD bases, and precoding coefficients for each TRP). That is, CSI reporting overhead may increase with the number of TRPs (e.g., N_{TRP}). In some cases, however, it may be appropriate to enable communications with a large number of TRPs or large number of ports (e.g., for low-frequency bands with distributed TRPs or panels). For instance, for a single-TRP or panel with e.g., 32 ports an antenna array size may be too large for practical deployment. Thus, the wireless communications system 100 may support efficient techniques supporting communications with multiple TRPs while minimizing CSI reporting overhead.

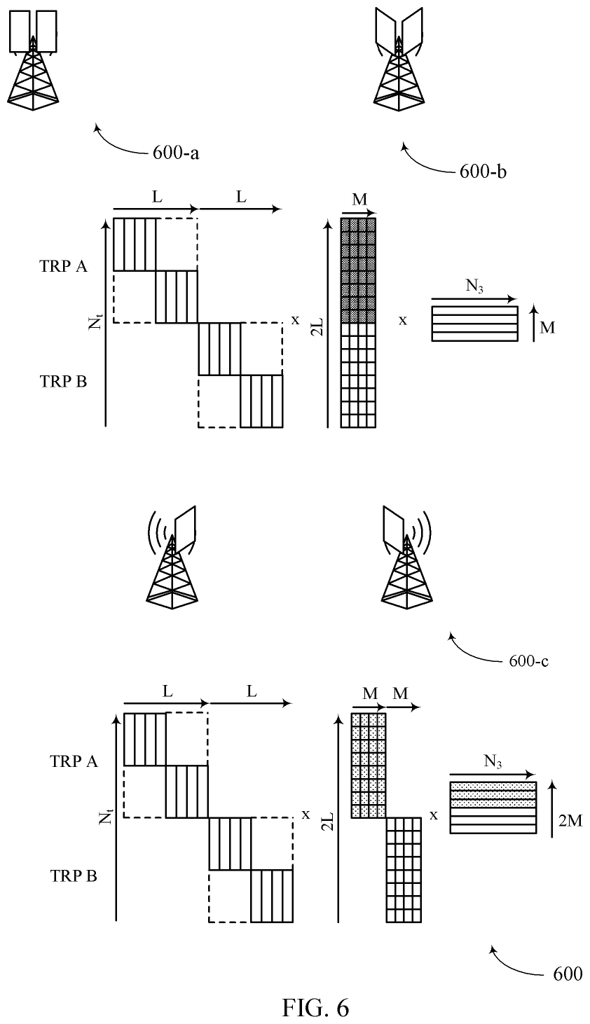

FIG. 6 illustrates an example of a orientations of different antenna panels used for CJTs 600 that supports NZC selection and SCI for CJT CSI in accordance with one or more aspects of the present disclosure. One or more TRPs may support coherent joint transmissions with backhaul communications and synchronization among the TRPs. In one aspect, co-located TRPs or antenna panels (e.g., intra-site) may be used for coherent joint transmissions. In the example 600-a, a TRP may use multiple antenna panels with a same orientation for coherent joint transmissions. In the example 600-b, a TRP may use multiple antenna panels with different orientations (e.g., inter-sector) for coherent joint transmissions. In another aspect, distributed TRPs (e.g., inter-site) may be used for coherent joint transmissions. This aspect is depicted in the example 600-c.

If co-located TRPs or antenna panels are used CJTs, a precoding matrix or precoder used for precoding data may be selected from a joint codebook. A precoding matrix for example 600-a, where the TRPs or antenna panels have joint FD and SD bases, may be given by equation 4, where a same SD basis selection matrix W_1 can be applied to both the two TRPs: TRP #A and TRP #B . . .

$$W = [ \begin{matrix}{W}_{1} & 0 \\ 0 & {W}_{1}\end{matrix} ] \times {\tilde{W}}_{2} \times {W}_{f}^{H} = [ \begin{matrix}{W}^{TRP \# A} \\ {W}^{TRP \# B}\end{matrix} ] \qquad ( 4 )$$

A precoding matrix for example 600-b, where the TRPs or antenna panels have joint FD bases and separate SD bases, may be given by equation 5.

$$W = [ \begin{matrix}{W}_{1 , A} & 0 \\ 0 & {W}_{1 , B}\end{matrix} ] \times {\tilde{W}}_{2} \times {W}_{f}^{H} = [ \begin{matrix}{W}^{TRP \# A} \\ {W}^{TRP \# B}\end{matrix} ] \qquad ( 5 )$$

If distributed TRPs are used for CJTs, for example as illustrated in example 600-c, precoding matrices or precoders used for precoding data may be selected from separate codebooks (e.g., separate FD and SD bases) and a co-amplitude or phase coefficient may be added to the precoding matrices or precoders. Such a precoding matrix or precoder may be given by equation 6.

$$W = [ \begin{matrix}{W}^{TRP \# A} \\ {q}_{1} {W}^{TRP \# B}\end{matrix} ] = [ \begin{matrix}{W}_{1 , A} \times {\tilde{W}}_{2 , A} \times {W}_{f , A}^{H} \\ {q}_{1} {W}_{1 , B} \times {\tilde{W}}_{2 , B} \times {W}_{f , B}^{H}\end{matrix} ] = [ \begin{matrix}{W}_{1 , A} & 0 \\ 0 & {W}_{1 , B}\end{matrix} ] \times [ \begin{matrix}{\tilde{W}}_{2 , A} & 0 \\ 0 & {q}_{1} {\tilde{W}}_{2 , B}\end{matrix} ] \times [ \begin{matrix}{W}_{f , A}^{H} \\ {W}_{f , B}^{H}\end{matrix} ] \qquad ( 6 )$$

For Type-II codebook refinement for CJT for multiTRP, the resulting codebook(s) may be associated with parameters for basis reporting, including the number of basis vectors (e.g., a SD and/or FD basis configuration), which may be configured by the network via higher-layer signaling. The basis selection indicator(s) (e.g., the SD and/or FD basis selection) may also be a port of the CSI report. The quantized combining coefficients (\tilde{W}₂) (e.g., the NZC selection and quantization of amplitude or phase) may be indicated as part of the CSI report. The number of NZCs and the bitmap to indicate the NZCs, including whether the bitmap is per TRP or per TRP group (e.g., separate) or across all TRPs or TRP groups (e.g., joint) may be indicated as part of the CSI report. The SCI(s) may be indicated as part of the CSI report.

For the \tilde{W}₂ coefficient quantization scheme for the Type-II codebook refinement for CJT for multi TRP, at least for N=2, alphabets for amplitude and phase may be reused from legacy per-coefficient quantization schemes. Additionally, or alternatively, quantization of phase and quantization of differential amplitude relative to a reference amplitude (with the SCI determining the location of the reference amplitude), and where the reference is defined for each layer and each group of coefficients may be reused from legacy per-coefficient quantization schemes.

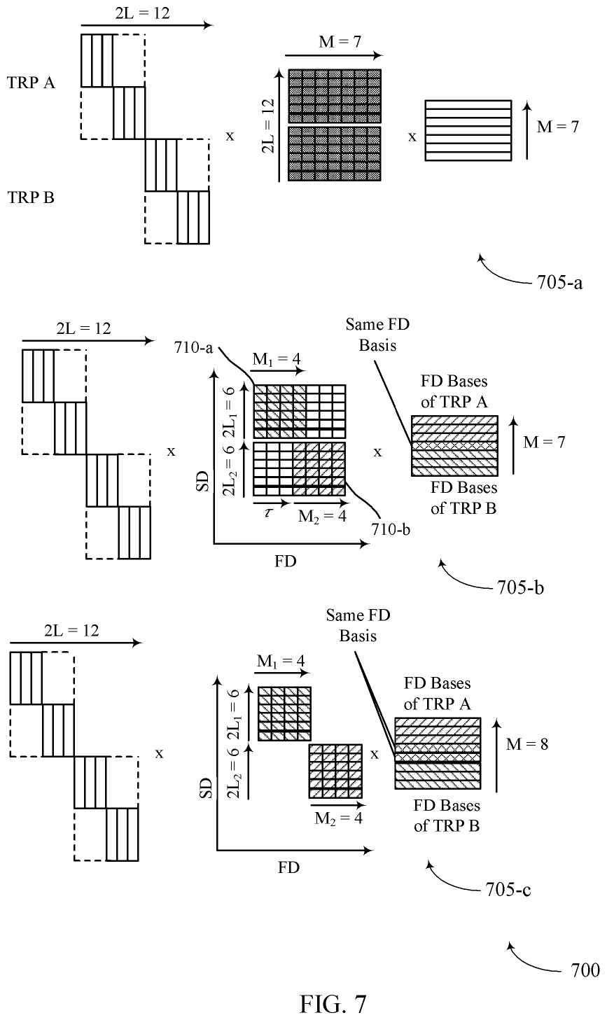

FIG. 7 illustrates an example of a selection of spatial and frequency bases that supports NZC selection and SCI for CJT CSI 700 that supports NZC selection and SCI for CJT CSI in accordance with one or more aspects of the present disclosure.

For joint codebook CJT, FD basis selection may be separately reported for different TRPs. By exploiting the delay difference t between, for example, reception of a signal from TRP B and TRP B, the FD basis selection may be reported to the TRP A and the TRP B separately. Reporting the FD basis selection separately for the TRP A and the TRP B may enable reduction in overhead in the NZC selection bitmap by using a block-wise (and in some cases a 2-level) indication of the NZC selection.

For example, example 705-a illustrates a case with M=7 and, for each of TRP A and TRP B, L=6, and accordingly 2L=12. Example 705-b illustrates a joint codebook FD basis selection for TRP A and TRP B. As illustrated in example 705-b, at least one of the FD bases for TRP A and TRP B may overlap.

Example 705-c illustrates a separate codebook FD basis selection for TRP A and TRP B. In the example 705-c, representing FD-separate codebook (e.g., where separate FD basis selection may be natural), FD basis columns do not overlap. For example, even when two TRPs (e.g., TRP A and TRP B) share a same selected FD basis, the shared FD basis is reported separately.

For joint codebook, as shown in the example 705-b, the bitmap size may be reduced by exploiting the delay difference t, and reporting the NZC selection on a block-wise basis. For M=7 and L=6, a bitmap for the joint FD bases selection example 705-b would involve 2L*M=84 bits. For M=7 and L=6. A block-wise reporting of the bitmap (e.g., reporting blocks 710-a and 710-b) would involve 2L₁*M₁+2L₂*M₂=48 bits. Accordingly, a block-wise indication of the NZC may reduce the bit overhead for reporting the NZC bitmap.

A difference between example 705-c and a joint codebook (e.g., as in example 705-b), may be that whether column overlap is allowed for the NZC blocks in the \tilde{W}₂ matrix, for separate codebook, even when two TRPs share a same selected FD basis, they may still be separately reported.

For Type=II CJT CSI with (at least partially) shared FD bases among TRPs (e.g., for joint codebook), the number of selected SD bases and FD bases (denoted Lₙ and Mₙ, respectively, for TRPs n=1, . . . , N) may be per-TRP configured by the network (e.g., via signaling from a network entity 105) or per-TRP reported by a UE. For the case that the number of SD bases or FD bases is per-TRP configured by the network, the values of Lₙ or Mₙ may be either TRP common or TRP specific for the TRPs n=1, . . . , N. For the case that the number of SD bases or FD bases is per-TRP reported by the UE, the configuration may be based on the total across the TRPs

$$( e . g . , L = {\sum }_{n = 1}^{N} {L}_{n} , M = \vert {⋃}_{n = 1}^{N} {W}_{f , n} \vert ,$$

where L refers to the total number of SD bases across the TRPs n=1, . . . , N and M refers to the total number of FD bases across the TRPs n=1, . . . , N. Table 2 below list the possible cases of whether the FD bases or SD bases are per-TRP configured by the network or per-TRP reported by the UE.

TABLE 2

| | Alt 1: Per-TRP | Alt 2: UE-reported Mₙ, (e.g., |
|---|---|---|
| | configured Mₙ | with total |
| | | $M = \vert {⋃}_{n = 1}^{N} {W}_{f , n} \vert$ |
| | | configured by the network) |
| Alt. 1: Per TRP | Case 1 | Case 3 |
| configured Lₙ | | |
| Alt. 2: UE-reported Lₙ | Case 2 | Case 4 |
| (e.g., with total | | |
| $L = {\sum }_{n = 1}^{N} {L}_{n}$ | | |
| configured by the network) | | |

For joint codebook, case 2 may be preferable to case 1, which may be preferable to case 4, which may be preferable to case 4. For the SD bases, configuring the total number of SD bases may be preferable to per-TRP SB basis configuration. For the FD basis, the per-TRP configuration by the network may be preferred to the per-TRP reported by the UE cases.

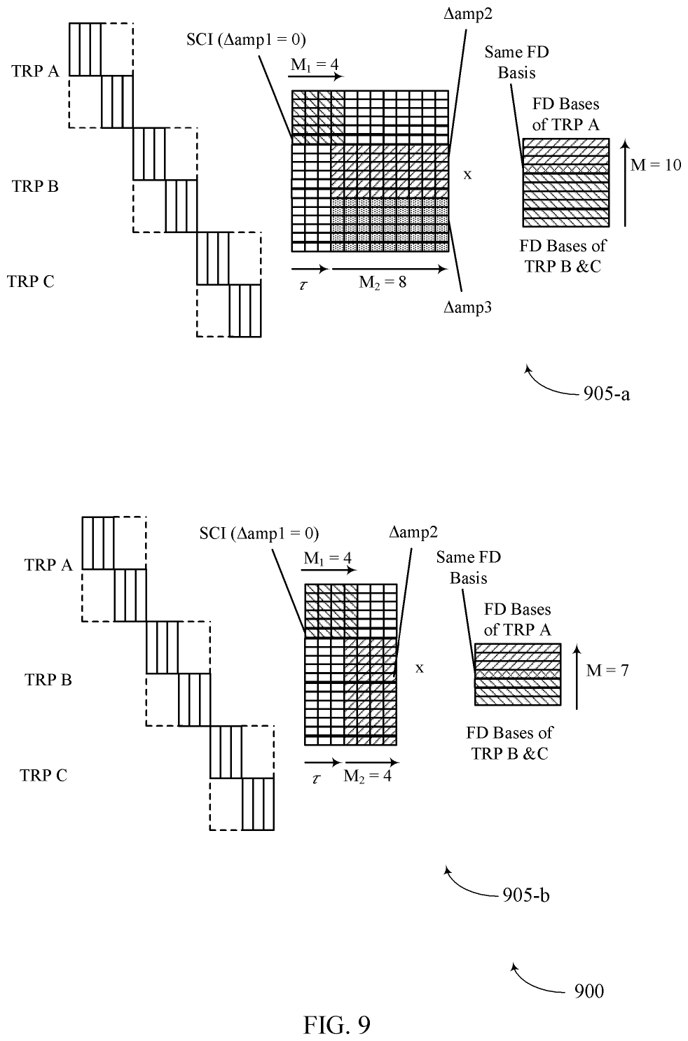

For UE reported Lₙ cases, the value of Lₙs may be reported (e.g., determined) with a CSI part 1, as described herein with reference to FIG. 9. For example, the Lₙs in CSI part 1 may be used by the network entity to determine the payload size of the SD basis selection and the NZC selection bitmap in the CSI part 2. In some cases, Lₙ may be explicitly reported in CSI part 1. In some cases, a network entity may implicitly determine the Lₙ according to the UE reported TRP selection in the CSI part 1. For example, with N TRPs selected and/or reported, semi-equal divided for the N TRPs: Lₙ=┌L/N┐ for first (L mod N) TRPs, and Lₙ=└L/N┘ for the remaining TRPs, where L is the configured total of SD bases (e.g., indicated by the network entity). For example, with L=8 and N=3, L1=L2=4 for the first 2 selected TRP, L3=3 for the last TRP selected.

For either network configured Lₙ or UE reported Lₙ cases, the layer-common SD basis selection indication in the CSI part 2 may include a first field separately indicating, for each TRP n=1, . . . , N, the oversampling group with log 2 bits (thus N log₂ O₁O₂ bits in total). For either network configured Lₙ or UE reported In cases, the layer-common SD basis selection indication in the CSI part 2 may include a second field separately indicating, for each for each TRP n=1, . . . , N, the selected Lₙ SD bases out of the N₁N₂ SD bases with

$$⌈ {log}_{2} ( \begin{matrix}{N}_{1} {N}_{2} \\ {L}_{n}\end{matrix} ) ⌉ bits ( thus {\sum }_{n = 1}^{N} ⌈ {log}_{2} ( \begin{matrix}{N}_{1} {N}_{2} \\ {L}_{n}\end{matrix} ) ⌉ bits in total ) .$$

For UE reported Mₙ cases, Mₙs may be determined with CSI part 1. For example, the Mₙs in CSI part 1 may be used by the network entity to determine the payload size of the FD basis selection and the NZC selection bitmap in the CSI part 2. In some cases, Mₙ may be explicitly reported in CSI part 1. In some cases, Mₙs may be implicitly determined by the network entity according to UE-reported TRP selection in CSI part 1. For example, with N TRPs selected/reported: a common value Mₙ=[γM/N] for the N TRPs n=1, . . . , N, where M is the configured total number of FD bases and γ≥1

For either network configured Mₙ or UE reported Mₙ cases, to maintain a comparable UCI overhead for a different number of TRPs selected, Mₙ may decrease with the number of TRPs selected (N). To maintain a comparable UCI overhead for ranks (e.g., number of layers), Mₙ may decrease with the rank.

For either network configured Mₙ or UE reported Mₙ cases, the layer-specific FD basis selection indication may be included in CSI part 2. A first field may indicate separately, for each TRP n=1, . . . , N, the window-location for window-based FD basis selection. The first field may not exist for non-window-based FD basis selection. A second field may indicate separately, for each TRP n=1, . . . , N, the selection of FD basis (either directly from N3 total bases—for non-window-based FD basis selection, or from the indicated windows—for window-based FD basis selection).

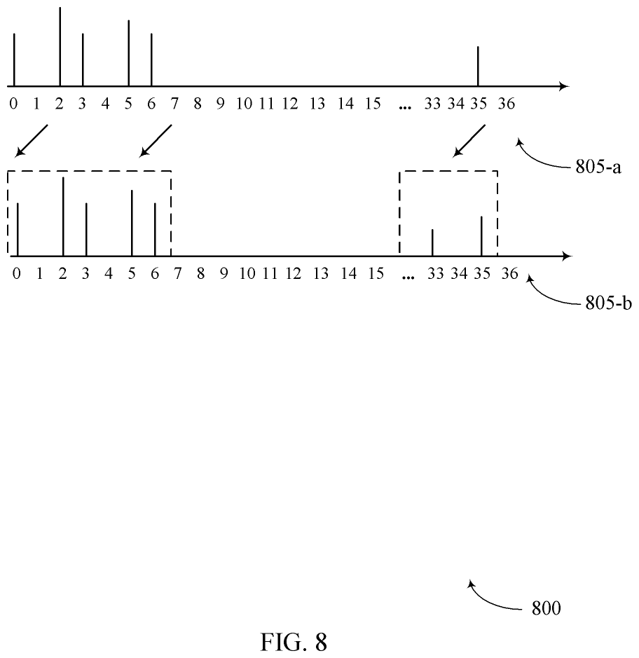

FIG. 8 illustrates an example of a FD basis selection method 800 that supports NZC selection and SCI for CJT CSI in accordance with one or more aspects of the present disclosure.

The FD basis selection (W_{f}) may be layer-specific. And for each layer, the strongest coefficient may be aligned at the FD basis 0. For example, the FD basis selection method 800 illustrates an FD basis index 805-a before index remapping and an FD basis index 805-b after index remapping. The index 805-a and the index 805-b illustrates an example with N₃=37 and M=5 (e.g., a window size of 2M=10).

At a first step, for a layer l, the FD basis index of the strongest coefficient (before the index remapping) may be denoted as

$${n}_{3 , l}^{( {m}_{l}^{*} )} . {n}_{3 , l}^{( {m}_{l}^{*} )}$$

may not be reported in a CSI report. At a second step the FD basis index

$${n}_{3 , l}^{( {m}_{l}^{*} )}$$

may be remapped (from the codebook) with respect to

$${n}_{3 , l}^{( {m}_{l}^{*} )} as {\tilde{n}}_{3 , l}^{( {m}_{l}^{*} )} = ( {n}_{3 , l}^{( {m}_{l}^{*} )} - {n}_{3 , l}^{( {m}_{l}^{*} )} )$$

mod N₃ such that

$${\tilde{n}}_{3 , l}^{( {m}_{l}^{*} )} = 0.$$

m may be as \tilde{m}=(m−m*ₗ) mod, such that \tilde{m}*ₗ=0. At a third step, the FR basis indices may be reported (after index remapping). For example,

$${\tilde{n}}_{3 , l}^{( {m}_{l}^{*} )}$$

may be reported for

$$m = 1 , … M - 1. {\tilde{n}}_{3 , l}^{( 0 )} = 0$$

may not be reported with the strongest coefficient.

For each layer, the FD basis selection may be directly 1-stage, or window based 2-stage, depending on the number of PMI subbands (N₃). For N₃≤19, the UE may directly report M−1 FD bases from N₃−1 candidate FD bases via

$$⌈ {log}_{2} ( \begin{matrix}{N}_{3} - 1 \\ M - 1\end{matrix} ) ⌉$$

(for each layer). For N₃>19, the UE may first report a starting index for a window-based intermediate set (down-select from N₃ to 2M) via ┌log₂ 2M┐ bits and may then report M−1 FD bases from 2M−1 candidate FD bases

$$⌈ {log}_{2} ( \begin{matrix}2 N - 1 \\ M - 1\end{matrix} ) ⌉$$

bits (for each layer). FD basis 0 may always be selected (e.g., because the strongest coefficient is aligned at FD basis 0).

FIG. 9 illustrates an example of a selection of spatial and frequency bases 900 that supports NZC selection and SCI for CJT CSI in accordance with one or more aspects of the present disclosure.

Three types of TRP groups may be defined. In a first group type (e.g., Type 1), TRPs within the group share a same FD basis selection indication in a CSI report. In a second group type (e.g., Type 2), TRPs within the group share a same SD basis selection indication in a CSI report. In a third group type (e.g., Type 3), TRPs within the group share a same FD and SD basis selection indication in a CSI report. The network may configure (e.g., may indicate in control signaling) TRP group types for TRPs. TRps within Type 3 and Type 2 TRP groups may be treated as one TRP for Mₙ configuration or reporting. TRPs within Type 3 or Type 2 TRP groups may be treated as one unit for TRP selection. For example, a 3-bit bitmap for 4-TRPs A, {B,C}, D, where {B,C} is configured as a Type 3 or a Type 2 TRP group.

Example 905-a shows a case where TRP B and TRP C are included in a Type 1 TRP group. Example 905-b shows a case where TRP B and TRP C are included in either a Type 2 or a Type 3 TRP group. As illustrated TRPs within a TRP-group (e.g., TRPs B and C in example 905-a or TRPs B and C in example 905-b), may share a same NZC selection bitmap (“block: in the \tilde{W}₂ matrix). One NZC bitmap may be associated with one or more number of delta amplitudes over a SCI per polarization. As shown in the example 905-a, a Type 1 TRP group may be associated with more than one delta amplitude (e.g., one per TRP). As shown in the example 905-b, a Type 2 or a Type 3 TRP group may be associated with one delta amplitude. For the TRP and polarization having the strongest coefficient, the delta amplitude=0. Delta amplitude refers to p_{ref} in equation 3.

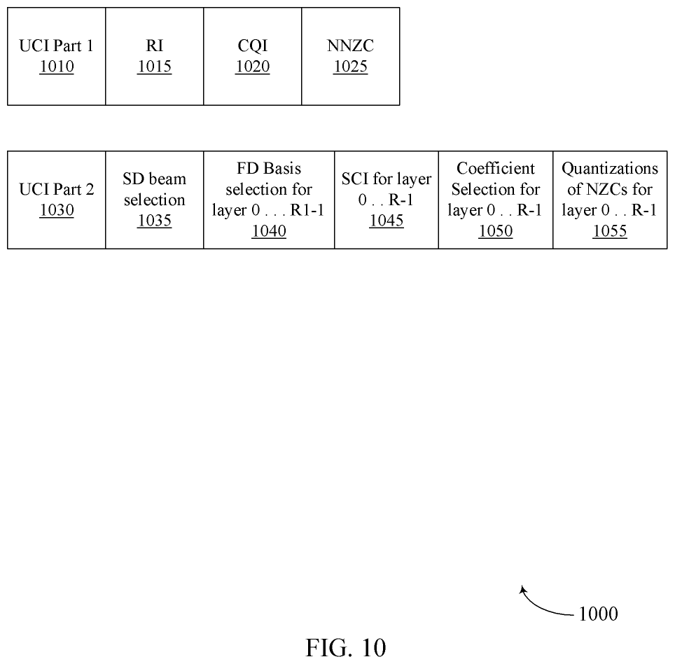

FIG. 10 illustrates an example of a UCI format 1000 that supports NZC selection and SCI for CJT CSI in accordance with one or more aspects of the present disclosure.

As described herein, a UE 115 may transmit a CSI report to a network entity via a UCI message, which may use the UCI format 1000. The UCI format 1000 may include a UCI part 1 1010 and a UCI part 2 1030.

UCI part 1 1010 may include a rank indicator (RI) field 1015, a CQI field 1020, and a number of NZC (NNZC) field 1025. The NNZC field 1025 may indicate the total number of NZCs across all layers,

$${K}_{NZ}^{tot} .$$

The bitwidth of the NNZC field 1025 may be log₂ 2K₀ bits.

UCI part 2 1030 may include an SD beam selection field 1035, a FD basis selection field 1040, an SCI field 1045, a coefficient selection field 1050, and a quantization of NZCs field 1055. The SD beam selection field 1035 may indicate the L beams out of N₁N₂O₁O₂ total beams. The bitwidth of the SD beam selection field 1035 may be i_{1,1}: log₂ O₁O₂ for a beam group and i_{1,2}:

$$⌈ {log}_{2} ( \begin{matrix}{N}_{1} {N}_{2} \\ L\end{matrix} ) ⌉$$

for a beam indication. The FD basis selection field 1040 may be used to select MRI FD bases for each layer out of N₃ FD bases. If N₃<19, i_{1,6,l} may be reported, with l=0, . . . Rl−1 using

$$⌈ {log}_{2} ( \begin{matrix}{N}_{3} \\ {M}_{RI}\end{matrix} ) ⌉ \times RI bits .$$

If N₃>19, a window based two-stage selection may be used. i_{1,1}, i_{1,2}, i_{1,5}, i_{1,6,l}, i_{1,7,l}, i_{1,8,l}, i_{2,3,l}, i_{2,4,l}, and i_{2,5,l} refer to codebook indices. The SCI field 1045 may be used to indicate the location of the strongest coefficients. For RI=1, the bitwidth of the SCI field 1045 may be

$$⌈ {log}_{2} {K}_{NZ}^{tot} ⌉ bits .$$

For RI>1, the bandwidth of the SCI field may be ┌log₂ 2L┐×RI bits. The coefficient selection field 1050 may indicate the location of NZCs within \tilde{W}_{2,l}. The bitwidth of the coefficient selection field 1050 may be given by RI sized 2 LM bitmaps, for a total of 2 LM×RI bits. The quantization of NZCs field 1055 may be used to indicate the amplitude or phase quantization. If i_{2,3,l}, the quantization of NZCs field 1055 may include 4 bits, to indicate the reference amplitude and the weaker polarizations. If i_{2,4,l}, the quantization of NZCs field 1055 may include

$$( {K}_{NZ}^{tot} - RI ) \times 3 bits ,$$

indicating the differential amplitude for each coefficient other than the strongest coefficient. If i_{2,5,l}, the quantization of NZCs field 1055 may include

$$( {K}_{NZ}^{tot} - RI ) \times 4 bits ,$$

indicating the phase for each coefficient other than the strongest coefficient.

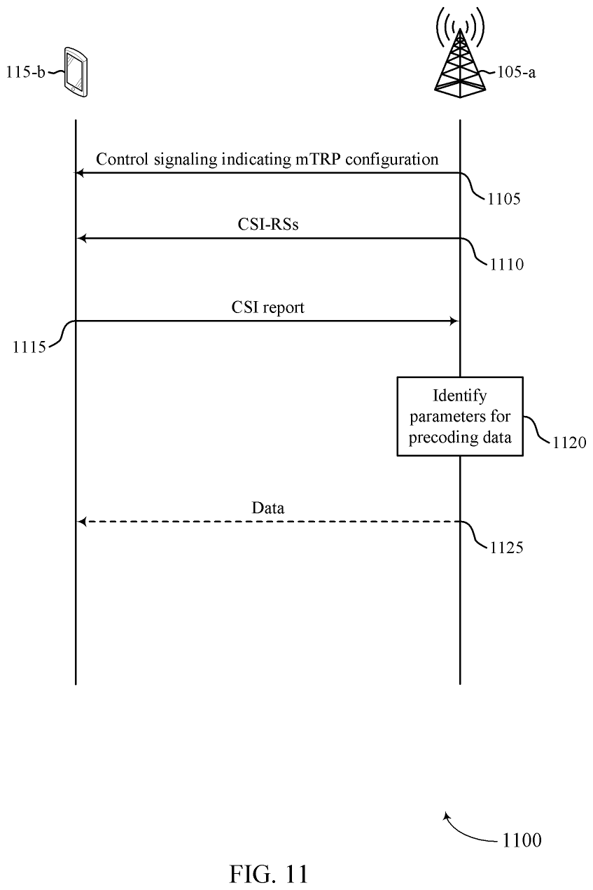

FIG. 11 illustrates an example of a process flow 1100 that supports NZC selection and SCI for CJT CSI in accordance with one or more aspects of the present disclosure. The process flow 1100 may include a UE 115-b, which may be an example of a UE 115 as described herein. The process flow 1100 may include a network entity 105-a, which may be an example of a network entity 105 as described herein. In the following description of the process flow 1100, the operations between the UE 115-b and network entity 105-a may be transmitted in a different order than the example order shown, or the operations performed by the UE 115-b and network entity 105-a may be performed in different orders or at different times. Some operations may also be omitted from the process flow 1100, and other operations may be added to the process flow 1100.

At 1105, the UE 115-b may receive, from the network entity 105-a, control signaling indicating a multi-TRP configuration for the UE 115-b to use to communicate with the network entity 105-a via a first TRP and a second TRP associated with the network entity 105-a.

At 1110, the UE 115-b may receive, channel state information reference signals from the first TRP and the second TRP according to the multi-TRP configuration. The network entity 105-a may transmit the CSI-RSs via the first TRP and the second TRP.

At 1115, the UE 115-b may transmit, to the network entity 105-a, a UCI message including a NZC bitmap that is based on measurements of the channel state information reference signals. A size in quantity of bits of the NZC bitmap is based on a quantity of FD bases and a quantity of SD bases associated with the first TRP and the second TRP. The FD bases associated with the first TRP at least partially overlap the FD bases associated with the second TRP.

In some examples, transmitting the UCI includes transmitting the UCI including one or more fields indicating a first quantity of FD bases associated with the first TRP and a second quantity of FD bases associated with the second TRP. The quantity of FD bases may be based on the first quantity and the second quantity.

In some examples, transmitting the UCI includes transmitting the UCI including one or more fields indicating a selection of the first TRP and the second TRP from a set of multiple TRPs. For example, the control signaling received at 1105 may indicate that the multi-TRP configuration for the UE to use to communicate with the network entity includes the set of multiple TRPs. In some examples, a quantity of FD bases per TRP is inversely related to a quantity of TRPs selected in UCI message.

In some examples, a quantity of FD bases per TRP is inversely related to a quantity of layers reported in the UCI message.

In some examples, transmitting the UCI includes transmitting the UCI including one or more fields indicating a first quantity of SD bases associated with the first TRP and a second quantity of SD bases associated with the second TRP. The quantity of SD bases may be based on the first quantity and the second quantity.

In some examples, receiving the control signaling at 1105 includes receiving an indication of a first quantity of FD bases associated with the first TRP and a second quantity of FD bases associated with the second TRP. The quantity of FD bases may be based on the first quantity and the second quantity.

In some examples, receiving the control signaling at 1105 includes receiving an indication of a first quantity of SD bases associated with the first TRP and a second quantity of SD bases associated with the second TRP. The quantity of SD bases may be based on the first quantity and the second quantity.

In some examples, transmitting the UCI includes transmitting the UCI including a set of fields indicating a layer-specific FD basis selection of a per-TRP basis.

In some examples, receiving the control signaling at 1105 includes receiving the control signaling indicating the first TRP and the second TRP share a same layer-specific FD basis selection. In some cases, transmitting the UCI further includes transmitting a first delta amplitude associated with the first TRP and a second delta amplitude associated with the second TRP, where the first delta amplitude and the second delta amplitude are over a strongest coefficient.

In some examples, transmitting the UCI includes transmitting the UCI including a set of fields indicating a layer-common SD basis selection on a per TRP basis.

In some examples, receiving the control signaling at 1105 includes receiving the control signaling indicating the first TRP and the second TRP share a same layer-common SD basis selection. In some cases, a first quantity of FD bases associated with the first TRP is the same as a second quantity of FD bases associated with the second TRP. In some cases, transmitting the UCI includes transmitting the UCI including a field indicating a selection of one of the first TRP or the second TRP from a plurality of TRPs, where the control signaling indicates the multi-TRP configuration for the UE to use to communicate with the network entity includes the set of multiple TRPs, and where the selection of one of the first TRP or the second TRP may be a selection of both the first TRP and the second TRP. In some cases, transmitting the UCI further includes transmitting a single delta amplitude associated with the first TRP and the second TRP, where the single delta amplitude is over a strongest coefficient.

In some examples, at 1120, the network entity 105-a may identify parameters for precoding data for transmission to the UE 115-b based on the CSI report in the UCI, for example, as shown with reference to FIG. 5. For instance, the network entity 105-a may identify a precoder for precoding data transmissions to the UE 115-b based on the SD bases, FD bases, and NZCs included in the CSI report. The network entity 105-a may then precode data for transmission to the UE 115-b using the precoder. In some examples, at 1125, the network entity 105-a may transmit data to the UE 115-b. For instance, the network entity 105-a may transmit at least one transmission in multiple transmissions forming a CJT to the UE 115-b. The phases and amplitudes of the multiple transmissions forming the CJT may be controlled and coordinated by the TRPs participating in the coherent joint transmission. Alternatively, the network entity 105-a may coordinate a CJT of the data to the UE 115-b. The UE 115-b may receive the CJT from multiple TRPs.

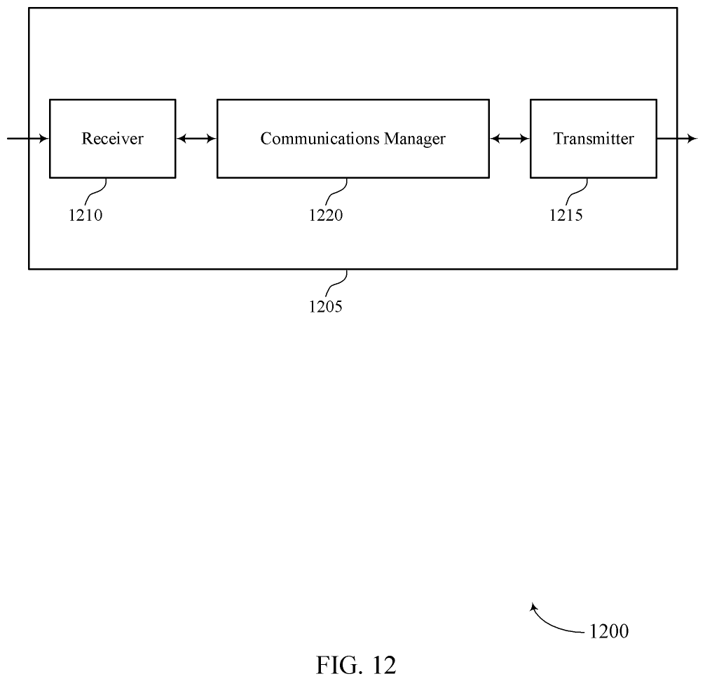

FIG. 12 shows a block diagram 1200 of a device 1205 that supports NZC selection and SCI for CJT CSI in accordance with one or more aspects of the present disclosure. The device 1205 may be an example of aspects of a UE 115 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for receiving information such as packets, user data, control information, or any combination thereof associated with various information channels (e.g., control channels, data channels, information channels related to NZC selection and SCI for CJT CSI). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to NZC selection and SCI for CJT CSI). In some examples, the transmitter 1215 may be co-located with a receiver 1210 in a transceiver module. The transmitter 1215 may utilize a single antenna or a set of multiple antennas.

The communications manager 1220, the receiver 1210, the transmitter 1215, or various combinations thereof or various components thereof may be examples of means for performing various aspects of NZC selection and SCI for CJT CSI as described herein. For example, the communications manager 1220, the receiver 1210, the transmitter 1215, or various combinations or components thereof may support a method for performing one or more of the functions described herein.

In some examples, the communications manager 1220, the receiver 1210, the transmitter 1215, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1220, the receiver 1210, the transmitter 1215, or various combinations or components thereof may be implemented in code (e.g., as communications management software or firmware) executed by a processor. If implemented in code executed by a processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications at a UE in accordance with examples as disclosed herein. For example, the communications manager 1220 may be configured as or otherwise support a means for receiving control signaling indicating a multi-TRP configuration for the UE to use to communicate with a network entity via a first TRP and a second TRP associated with the network entity. The communications manager 1220 may be configured as or otherwise support a means for receiving CSI-RSs from the first TRP and the second TRP according to the multi-TRP configuration. The communications manager 1220 may be configured as or otherwise support a means for transmitting, to the network entity, a UCI message including a NZC bitmap that is based on measurements of the CSI-RSs, where a size in quantity of bits of the NZC bitmap is based on a quantity of FD bases and a quantity of SD bases associated with the first TRP and the second TRP, where the FD bases associated with the first TRP at least partially overlap the FD bases associated with the second TRP.

By including or configuring the communications manager 1220 in accordance with examples as described herein, the device 1205 (e.g., a processor controlling or otherwise coupled with the receiver 1210, the transmitter 1215, the communications manager 1220, or a combination thereof) may support techniques for reduced processing and more efficient utilization of communication resources.

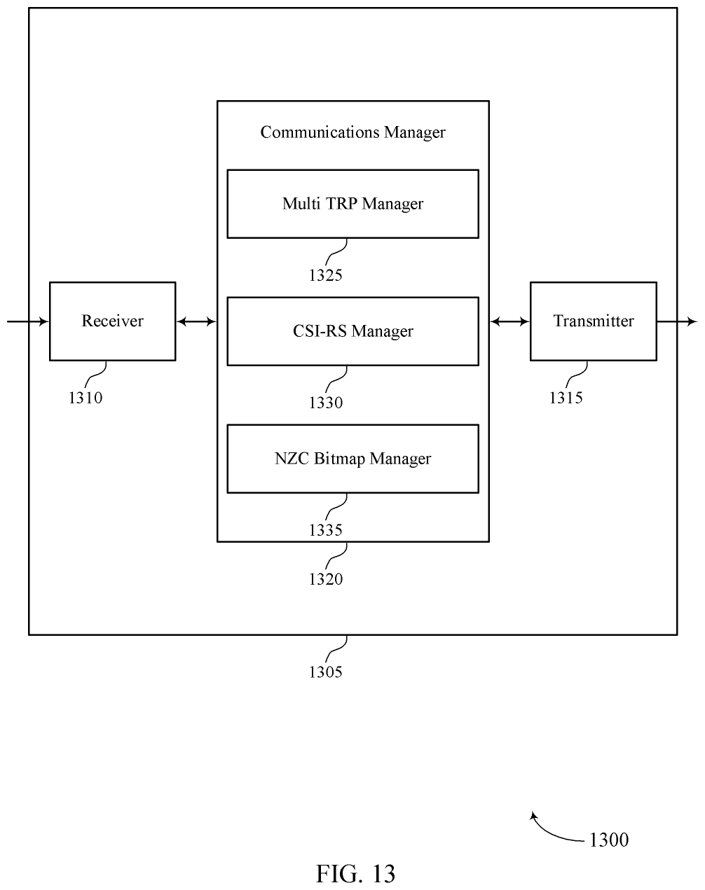

FIG. 13 shows a block diagram 1300 of a device 1305 that supports NZC selection and SCI for CJT CSI in accordance with one or more aspects of the present disclosure. The device 1305 may be an example of aspects of a device 1205 or a UE 115 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for receiving information such as packets, user data, control information, or any combination thereof associated with various information channels (e.g., control channels, data channels, information channels related to NZC selection and SCI for CJT CSI). Information may be passed on to other components of the device 1305. The receiver 1310 may utilize a single antenna or a set of multiple antennas.

The transmitter 1315 may provide a means for transmitting signals generated by other components of the device 1305. For example, the transmitter 1315 may transmit information such as packets, user data, control information, or any combination thereof associated with various information channels (e.g., control channels, data channels, information channels related to NZC selection and SCI for CJT CSI). In some examples, the transmitter 1315 may be co-located with a receiver 1310 in a transceiver module. The transmitter 1315 may utilize a single antenna or a set of multiple antennas.

The device 1305, or various components thereof, may be an example of means for performing various aspects of NZC selection and SCI for CJT CSI as described herein. For example, the communications manager 1320 may include a multi TRP manager 1325, a CSI-RS manager 1330, an NZC bitmap manager 1335, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications at a UE in accordance with examples as disclosed herein. The multi TRP manager 1325 may be configured as or otherwise support a means for receiving control signaling indicating a multi-TRP configuration for the UE to use to communicate with a network entity via a first TRP and a second TRP associated with the network entity. The CSI-RS manager 1330 may be configured as or otherwise support a means for receiving CSI-RSs from the first TRP and the second TRP according to the multi-TRP configuration. The NZC bitmap manager 1335 may be configured as or otherwise support a means for transmitting, to the network entity, a UCI message including a NZC bitmap that is based on measurements of the CSI-RSs, where a size in quantity of bits of the NZC bitmap is based on a quantity of FD bases and a quantity of SD bases associated with the first TRP and the second TRP, where the FD bases associated with the first TRP at least partially overlap the FD bases associated with the second TRP.

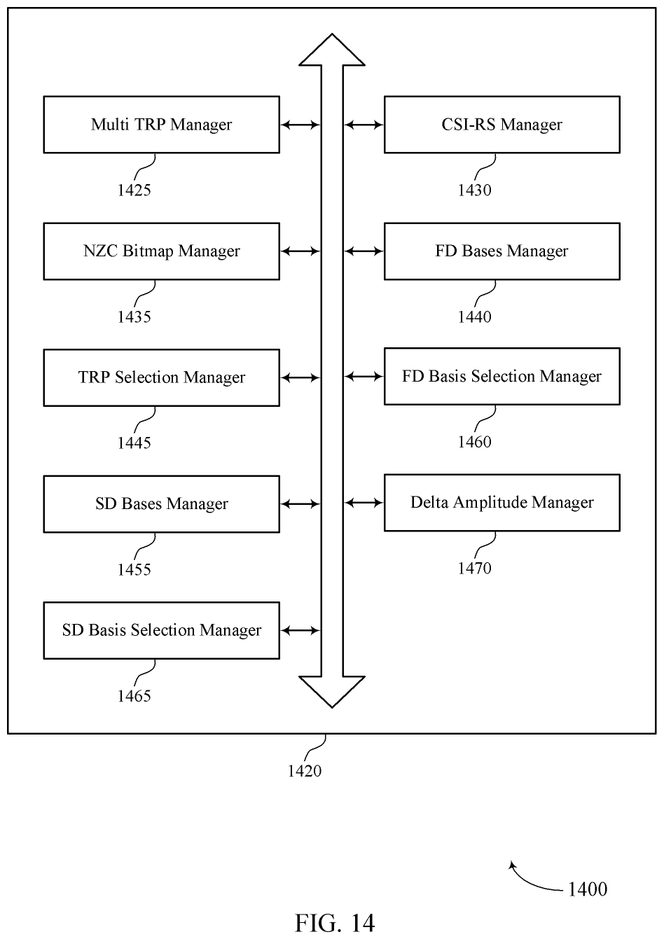

FIG. 14 shows a block diagram 1400 of a communications manager 1420 that supports NZC selection and SCI for CJT CSI in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of NZC selection and SCI for CJT CSI as described herein. For example, the communications manager 1420 may include a multi TRP manager 1425, a CSI-RS manager 1430, an NZC bitmap manager 1435, an FD bases manager 1440, an TRP selection manager 1445, an SD bases manager 1455, an FD basis selection manager 1460, an SD basis selection manager 1465, a delta amplitude manager 1470, or any combination thereof. Each of these components may communicate, directly or indirectly, with one another (e.g., via one or more buses).

The communications manager 1420 may support wireless communications at a UE in accordance with examples as disclosed herein. The multi TRP manager 1425 may be configured as or otherwise support a means for receiving control signaling indicating a multi-TRP configuration for the UE to use to communicate with a network entity via a first TRP and a second TRP associated with the network entity. The CSI-RS manager 1430 may be configured as or otherwise support a means for receiving CSI-RSs from the first TRP and the second TRP according to the multi-TRP configuration. The NZC bitmap manager 1435 may be configured as or otherwise support a means for transmitting, to the network entity, a UCI message including a NZC bitmap that is based on measurements of the CSI-RSs, where a size in quantity of bits of the NZC bitmap is based on a quantity of FD bases and a quantity of SD bases associated with the first TRP and the second TRP, where the FD bases associated with the first TRP at least partially overlap the FD bases associated with the second TRP.

In some examples, to support transmitting the UCI message, the FD bases manager 1440 may be configured as or otherwise support a means for transmitting the UCI message including one or more fields indicating a first quantity of FD bases associated with the first TRP and a second quantity of FD bases associated with the second TRP, where the quantity of FD bases is based on the first quantity and the second quantity.

In some examples, to support receiving the control signaling, FD bases manager 1440 may be configured as or otherwise support a means for receiving an indication of a first quantity of FD bases associated with the first TRP and a second quantity of FD bases associated with the second TRP, where the quantity of FD bases is based on the first quantity and the second quantity.

In some examples, to support transmitting the UCI message, the TRP selection manager 1445 may be configured as or otherwise support a means for transmitting the UCI message including one or more fields indicating a selection of the first TRP and the second TRP from a set of multiple TRPs, where the control signaling indicates the multi-TRP configuration for the UE to use to communicate with the network entity including the set of multiple TRPs.

In some examples, a quantity of FD bases per TRP is inversely related to a quantity of TRPs selected in the UCI message. In some examples, a quantity of FD bases per TRP is inversely related to a quantity of layers reported in the UCI message.

In some examples, to support transmitting the UCI message, the SD bases manager 1455 may be configured as or otherwise support a means for transmitting the UCI message including one or more fields indicating a first quantity of SD bases associated with the first TRP and a second quantity of SD bases associated with the second TRP, where the quantity of SD bases is based on the first quantity and the second quantity.

In some examples, to support receiving the control signaling, the SD bases manager 1455 may be configured as or otherwise support a means for receiving an indication of a first quantity of SD bases associated with the first TRP and a second quantity of SD bases associated with the second TRP, where the quantity of SD bases is based on the first quantity and the second quantity.

In some examples, to support transmitting the UCI message, the FD basis selection manager 1460 may be configured as or otherwise support a means for transmitting the UCI message including a set of fields indicating a layer-specific FD basis selection of a per-TRP basis.

In some examples, to support receiving the control signaling, the delta amplitude manager 1470 may be configured as or otherwise support a means for receiving the control signaling indicating the first TRP and the second TRP share a same layer-specific FD basis selection.

In some examples, to support receiving the control signaling, the delta amplitude manager 1470 may be configured as or otherwise support a means for transmitting a first delta amplitude associated with the TRP and a second delta amplitude associated with the second TRP, where the first delta amplitude and the second delta amplitude are over a strongest coefficient.

In some examples, to support transmitting the UCI message, the SD basis selection manager 1465 may be configured as or otherwise support a means for transmitting the UCI message including a set of fields indicating a layer-common SD basis selection on a per TRP basis.

In some examples, to support receiving the control signaling, the SD basis selection manager 1465 may be configured as or otherwise support a means for receiving the control signaling indicating the first TRP and the second TRP share a same layer-common SD basis selection.

In some examples, a first quantity of FD bases associated with the first TRP is the same as a second quantity of FD bases associated with the second TRP.

In some examples, to support transmitting the UCI message, the TRP selection manager 1445 may be configured as or otherwise support a means for transmitting the UCI message including a field indicating a selection of one of the first TRP or the second TRP from a set of multiple TRPs, where the control signaling indicates the multi-TRP configuration for the UE to use to communicate with the network entity including the set of multiple TRPs, and where the selection of one of the first TRP or the second TRP includes a selection of both the first TRP and the second TRP.

In some examples, to support transmitting the UCI message, the delta amplitude manager 1470 may be configured as or otherwise support a means for transmitting a single delta amplitude associated with the first TRP and the second TRP, where the single delta amplitude is over a strongest coefficient.

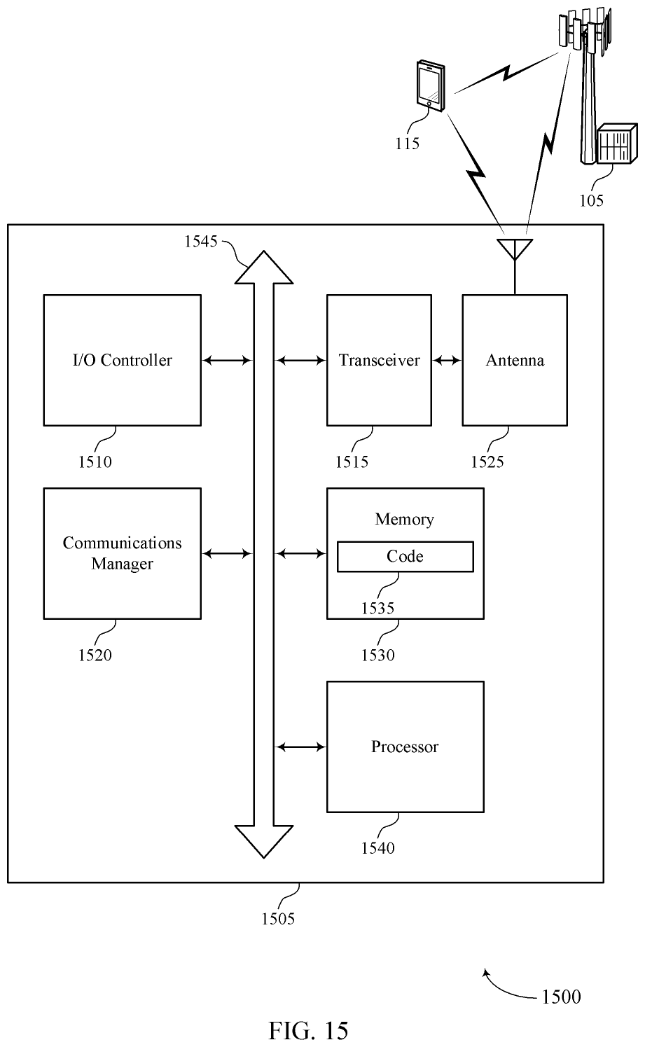

FIG. 15 shows a diagram of a system 1500 including a device 1505 that supports NZC selection and SCI for CJT CSI in accordance with one or more aspects of the present disclosure. The device 1505 may be an example of or include the components of a device 1205, a device 1305, or a UE 115 as described herein. The device 1505 may communicate (e.g., wirelessly) with one or more network entities 105, one or more UEs 115, or any combination thereof. The device 1505 may include components for bi-directional voice and data communications including components for transmitting and receiving communications, such as a communications manager 1520, an input/output (I/O) controller 1510, a transceiver 1515, an antenna 1525, a memory 1530, code 1535, and a processor 1540. These components may be in electronic communication or otherwise coupled (e.g., operatively, communicatively, functionally, electronically, electrically) via one or more buses (e.g., a bus 1545).

The I/O controller 1510 may manage input and output signals for the device 1505. The I/O controller 1510 may also manage peripherals not integrated into the device 1505. In some cases, the I/O controller 1510 may represent a physical connection or port to an external peripheral. In some cases, the I/O controller 1510 may utilize an operating system such as iOS®, ANDROID®, MS-DOS®, MS-WINDOWS®, OS/2®, UNIX®, LINUX®, or another known operating system. Additionally, or alternatively, the I/O controller 1510 may represent or interact with a modem, a keyboard, a mouse, a touchscreen, or a similar device. In some cases, the I/O controller 1510 may be implemented as part of a processor, such as the processor 1540. In some cases, a user may interact with the device 1505 via the I/O controller 1510 or via hardware components controlled by the I/O controller 1510.

In some cases, the device 1505 may include a single antenna 1525. However, in some other cases, the device 1505 may have more than one antenna 1525, which may be capable of concurrently transmitting or receiving multiple wireless transmissions. The transceiver 1515 may communicate bi-directionally, via the one or more antennas 1525, wired, or wireless links as described herein. For example, the transceiver 1515 may represent a wireless transceiver and may communicate bi-directionally with another wireless transceiver. The transceiver 1515 may also include a modem to modulate the packets, to provide the modulated packets to one or more antennas 1525 for transmission, and to demodulate packets received from the one or more antennas 1525. The transceiver 1515, or the transceiver 1515 and one or more antennas 1525, may be an example of a transmitter 1215, a transmitter 1315, a receiver 1210, a receiver 1310, or any combination thereof or component thereof, as described herein.

The memory 1530 may include random access memory (RAM) and read-only memory (ROM). The memory 1530 may store computer-readable, computer-executable code 1535 including instructions that, when executed by the processor 1540, cause the device 1505 to perform various functions described herein. The code 1535 may be stored in a non-transitory computer-readable medium such as system memory or another type of memory. In some cases, the code 1535 may not be directly executable by the processor 1540 but may cause a computer (e.g., when compiled and executed) to perform functions described herein. In some cases, the memory 1530 may contain, among other things, a basic I/O system (BIOS) which may control basic hardware or software operation such as the interaction with peripheral components or devices.

The processor 1540 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1540 may be configured to operate a memory array using a memory controller. In some other cases, a memory controller may be integrated into the processor 1540. The processor 1540 may be configured to execute computer-readable instructions stored in a memory (e.g., the memory 1530) to cause the device 1505 to perform various functions (e.g., functions or tasks supporting NZC selection and SCI for CJT CSI). For example, the device 1505 or a component of the device 1505 may include a processor 1540 and memory 1530 coupled with or to the processor 1540, the processor 1540 and memory 1530 configured to perform various functions described herein.

The communications manager 1520 may support wireless communications at a UE in accordance with examples as disclosed herein. For example, the communications manager 1520 may be configured as or otherwise support a means for receiving control signaling indicating a multi-TRP configuration for the UE to use to communicate with a network entity via a first TRP and a second TRP associated with the network entity. The communications manager 1520 may be configured as or otherwise support a means for receiving CSI-RSs from the first TRP and the second TRP according to the multi-TRP configuration. The communications manager 1520 may be configured as or otherwise support a means for transmitting, to the network entity, a UCI message including a NZC bitmap that is based on measurements of the CSI-RSs, where a size in quantity of bits of the NZC bitmap is based on a quantity of FD bases and a quantity of SD bases associated with the first TRP and the second TRP, where the FD bases associated with the first TRP at least partially overlap the FD bases associated with the second TRP.

By including or configuring the communications manager 1520 in accordance with examples as described herein, the device 1505 may support techniques for improved communication reliability, more efficient utilization of communication resources, improved coordination between devices, and improved utilization of processing capability.

In some examples, the communications manager 1520 may be configured to perform various operations (e.g., receiving, monitoring, transmitting) using or otherwise in cooperation with the transceiver 1515, the one or more antennas 1525, or any combination thereof. For example, the communications manager 1520 may be configured to receive or transmit messages or other signaling as described herein via the transceiver 1515. Although the communications manager 1520 is illustrated as a separate component, in some examples, one or more functions described with reference to the communications manager 1520 may be supported by or performed by the processor 1540, the memory 1530, the code 1535, or any combination thereof. For example, the code 1535 may include instructions executable by the processor 1540 to cause the device 1505 to perform various aspects of NZC selection and SCI for CJT CSI as described herein, or the processor 1540 and the memory 1530 may be otherwise configured to perform or support such operations.

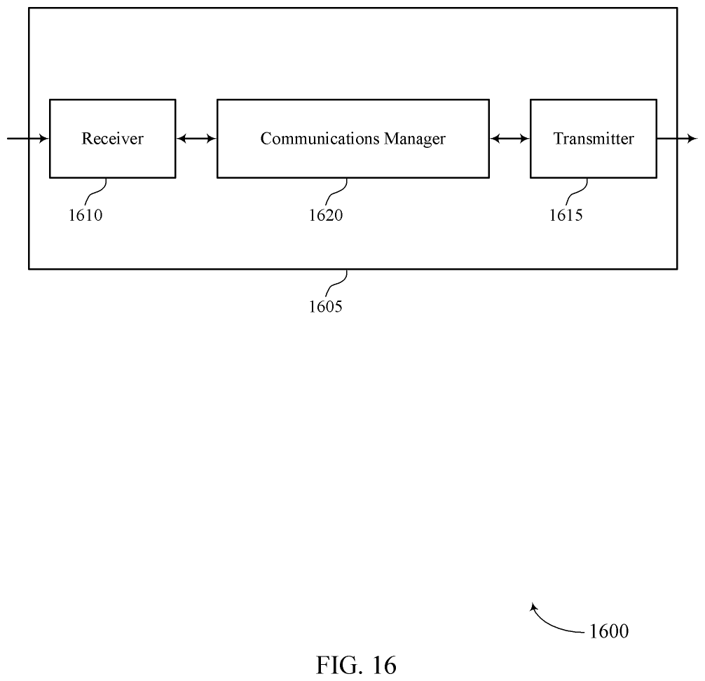

FIG. 16 shows a block diagram 1600 of a device 1605 that supports NZC selection and SCI for CJT CSI in accordance with one or more aspects of the present disclosure. The device 1605 may be an example of aspects of a network entity 105 as described herein. The device 1605 may include a receiver 1610, a transmitter 1615, and a communications manager 1620. The device 1605 may also include a processor. Each of these components may be in communication with one another (e.g., via one or more buses).

The receiver 1610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1605. In some examples, the receiver 1610 may support obtaining information by receiving signals via one or more antennas. Additionally, or alternatively, the receiver 1610 may support obtaining information by receiving signals via one or more wired (e.g., electrical, fiber optic) interfaces, wireless interfaces, or any combination thereof.

The transmitter 1615 may provide a means for outputting (e.g., transmitting, providing, conveying, sending) information generated by other components of the device 1605. For example, the transmitter 1615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1615 may support outputting information by transmitting signals via one or more antennas. Additionally, or alternatively, the transmitter 1615 may support outputting information by transmitting signals via one or more wired (e.g., electrical, fiber optic) interfaces, wireless interfaces, or any combination thereof. In some examples, the transmitter 1615 and the receiver 1610 may be co-located in a transceiver, which may include or be coupled with a modem.

The communications manager 1620, the receiver 1610, the transmitter 1615, or various combinations thereof or various components thereof may be examples of means for performing various aspects of NZC selection and SCI for CJT CSI as described herein. For example, the communications manager 1620, the receiver 1610, the transmitter 1615, or various combinations or components thereof may support a method for performing one or more of the functions described herein.

In some examples, the communications manager 1620, the receiver 1610, the transmitter 1615, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1620, the receiver 1610, the transmitter 1615, or various combinations or components thereof may be implemented in code (e.g., as communications management software or firmware) executed by a processor. If implemented in code executed by a processor, the functions of the communications manager 1620, the receiver 1610, the transmitter 1615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1620 may be configured to perform various operations (e.g., receiving, obtaining, monitoring, outputting, transmitting) using or otherwise in cooperation with the receiver 1610, the transmitter 1615, or both. For example, the communications manager 1620 may receive information from the receiver 1610, send information to the transmitter 1615, or be integrated in combination with the receiver 1610, the transmitter 1615, or both to obtain information, output information, or perform various other operations as described herein.

The communications manager 1620 may support wireless communications at a network entity in accordance with examples as disclosed herein. For example, the communications manager 1620 may be configured as or otherwise support a means for transmitting, to a UE, control signaling indicating a multi-TRP configuration for the UE to use to communicate with the network entity via a first TRP and a second TRP associated with the network entity. The communications manager 1620 may be configured as or otherwise support a means for transmitting, via the first TRP and the second TRP, CSI-RSs according to the multi-TRP configuration. The communications manager 1620 may be configured as or otherwise support a means for receiving, from the UE and in response to the CSI-RSs, a UCI message including a NZC bitmap, where a size in quantity of bits of the NZC bitmap is based on a quantity of FD bases and a quantity of SD bases associated with the first TRP and the second TRP, where the FD bases associated with the first TRP at least partially overlap the FD bases associated with the second TRP.

By including or configuring the communications manager 1620 in accordance with examples as described herein, the device 1605 (e.g., a processor controlling or otherwise coupled with the receiver 1610, the transmitter 1615, the communications manager 1620, or a combination thereof) may support techniques for reduced processing and more efficient utilization of communication resources.

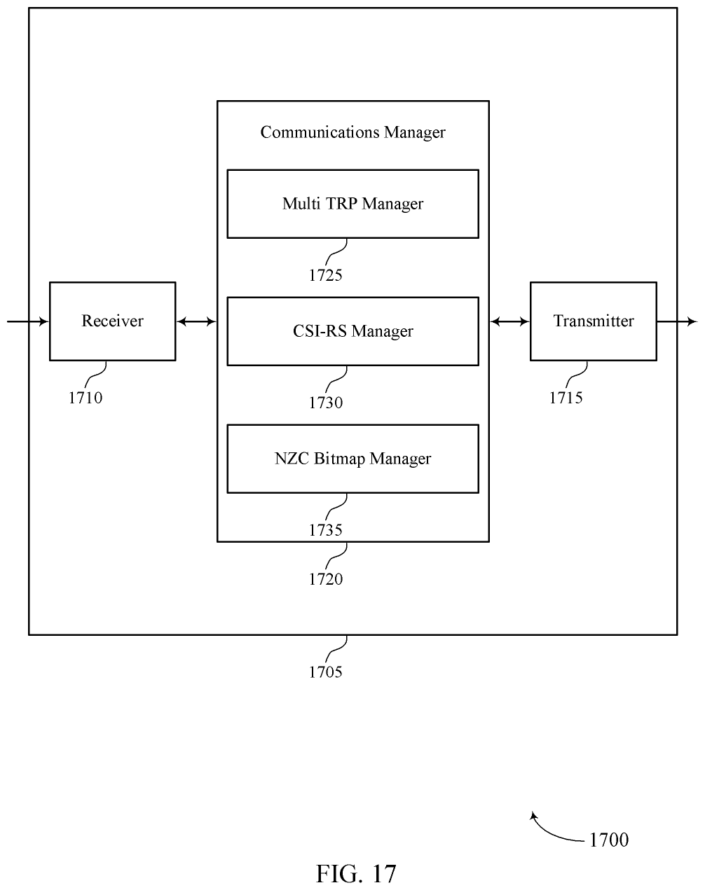

FIG. 17 shows a block diagram 1700 of a device 1705 that supports NZC selection and SCI for CJT CSI in accordance with one or more aspects of the present disclosure. The device 1705 may be an example of aspects of a device 1605 or a network entity 105 as described herein. The device 1705 may include a receiver 1710, a transmitter 1715, and a communications manager 1720. The device 1705 may also include a processor. Each of these components may be in communication with one another (e.g., via one or more buses).

The receiver 1710 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1705. In some examples, the receiver 1710 may support obtaining information by receiving signals via one or more antennas. Additionally, or alternatively, the receiver 1710 may support obtaining information by receiving signals via one or more wired (e.g., electrical, fiber optic) interfaces, wireless interfaces, or any combination thereof.

The transmitter 1715 may provide a means for outputting (e.g., transmitting, providing, conveying, sending) information generated by other components of the device 1705. For example, the transmitter 1715 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1715 may support outputting information by transmitting signals via one or more antennas. Additionally, or alternatively, the transmitter 1715 may support outputting information by transmitting signals via one or more wired (e.g., electrical, fiber optic) interfaces, wireless interfaces, or any combination thereof. In some examples, the transmitter 1715 and the receiver 1710 may be co-located in a transceiver, which may include or be coupled with a modem.

The device 1705, or various components thereof, may be an example of means for performing various aspects of NZC selection and SCI for CJT CSI as described herein. For example, the communications manager 1720 may include a multi TRP manager 1725, a CSI-RS manager 1730, an NZC bitmap manager 1735, or any combination thereof. The communications manager 1720 may be an example of aspects of a communications manager 1620 as described herein. In some examples, the communications manager 1720, or various components thereof, may be configured to perform various operations (e.g., receiving, obtaining, monitoring, outputting, transmitting) using or otherwise in cooperation with the receiver 1710, the transmitter 1715, or both. For example, the communications manager 1720 may receive information from the receiver 1710, send information to the transmitter 1715, or be integrated in combination with the receiver 1710, the transmitter 1715, or both to obtain information, output information, or perform various other operations as described herein.

The communications manager 1720 may support wireless communications at a network entity in accordance with examples as disclosed herein. The multi TRP manager 1725 may be configured as or otherwise support a means for transmitting, to a UE, control signaling indicating a multi-TRP configuration for the UE to use to communicate with the network entity via a first TRP and a second TRP associated with the network entity. The CSI-RS manager 1730 may be configured as or otherwise support a means for transmitting, via the first TRP and the second TRP, CSI-RSs according to the multi-TRP configuration. The NZC bitmap manager 1735 may be configured as or otherwise support a means for receiving, from the UE and in response to the CSI-RSs, a UCI message including a NZC bitmap, where a size in quantity of bits of the NZC bitmap is based on a quantity of FD bases and a quantity of SD bases associated with the first TRP and the second TRP, where the FD bases associated with the first TRP at least partially overlap the FD bases associated with the second TRP.

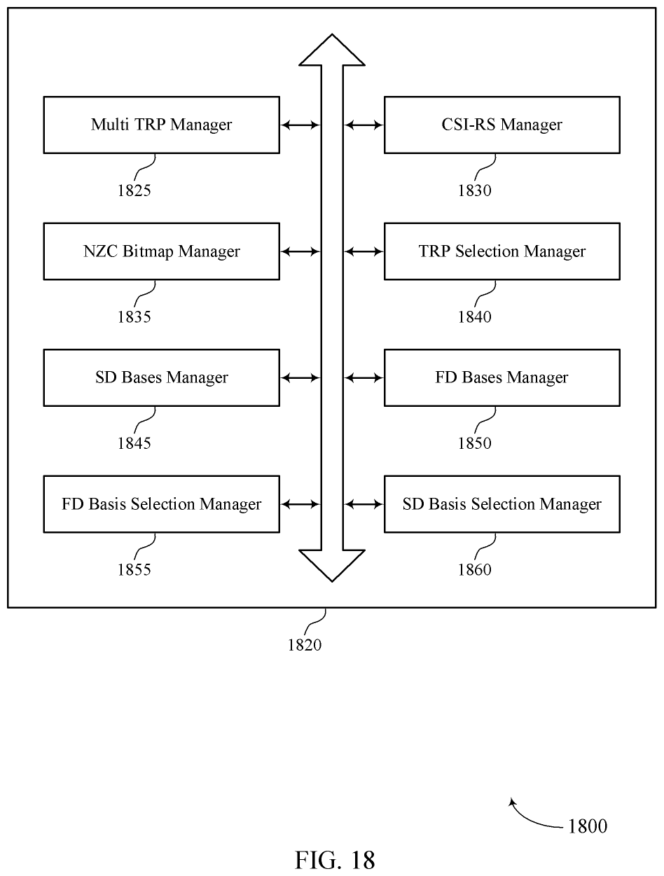

FIG. 18 shows a block diagram 1800 of a communications manager 1820 that supports NZC selection and SCI for CJT CSI in accordance with one or more aspects of the present disclosure. The communications manager 1820 may be an example of aspects of a communications manager 1620, a communications manager 1720, or both, as described herein. The communications manager 1820, or various components thereof, may be an example of means for performing various aspects of NZC selection and SCI for CJT CSI as described herein. For example, the communications manager 1820 may include a multi TRP manager 1825, a CSI-RS manager 1830, an NZC bitmap manager 1835, an TRP selection manager 1840, an SD bases manager 1845, an FD bases manager 1850, an FD basis selection manager 1855, an SD basis selection manager 1860, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1820 may support wireless communications at a network entity in accordance with examples as disclosed herein. The multi TRP manager 1825 may be configured as or otherwise support a means for transmitting, to a UE, control signaling indicating a multi-TRP configuration for the UE to use to communicate with the network entity via a first TRP and a second TRP associated with the network entity. The CSI-RS manager 1830 may be configured as or otherwise support a means for transmitting, via the first TRP and the second TRP, CSI-RSs according to the multi-TRP configuration. The NZC bitmap manager 1835 may be configured as or otherwise support a means for receiving, from the UE and in response to the CSI-RSs, a UCI message including a NZC bitmap, where a size in quantity of bits of the NZC bitmap is based on a quantity of FD bases and a quantity of SD bases associated with the first TRP and the second TRP, where the FD bases associated with the first TRP at least partially overlap the FD bases associated with the second TRP.

In some examples, to support receiving the UCI message, the TRP selection manager 1840 may be configured as or otherwise support a means for receiving the UCI message including one or more fields indicating a selection of the first TRP and the second TRP from a set of multiple TRPs, where the control signaling indicates the multi-TRP configuration for the UE to use to communicate with the network entity including the set of multiple TRPs.

In some examples, a quantity of FD bases per TRP is inversely related to a quantity of layers reported in the UCI message.

In some examples, to support receiving the UCI message, the SD bases manager 1845 may be configured as or otherwise support a means for receiving the UCI message including one or more fields indicating a first quantity of SD bases associated with the first TRP and a second quantity of SD bases associated with the second TRP, where the quantity of SD bases is based on the first quantity and the second quantity.

In some examples, to support transmitting the control signaling, the FD bases manager 1850 may be configured as or otherwise support a means for transmitting an indication of a first quantity of FD bases associated with the first TRP and a second quantity of FD bases associated with the second TRP, where the quantity of FD bases is based on the first quantity and the second quantity.

In some examples, to support transmitting the control signaling, the SD bases manager 1845 may be configured as or otherwise support a means for transmitting an indication of a first quantity of SD bases associated with the first TRP and a second quantity of SD bases associated with the second TRP, where the quantity of FD bases is based on the first quantity and the second quantity.

In some examples, to support receiving the UCI message, the FD basis selection manager 1855 may be configured as or otherwise support a means for receiving the UCI message including a set of fields indicating a layer-specific FD basis selection of a per-TRP basis.

In some examples, to support transmitting the UCI message, the SD basis selection manager 1860 may be configured as or otherwise support a means for transmitting the UCI message including a set of fields indicating a layer-common SD basis selection on a per TRP basis.

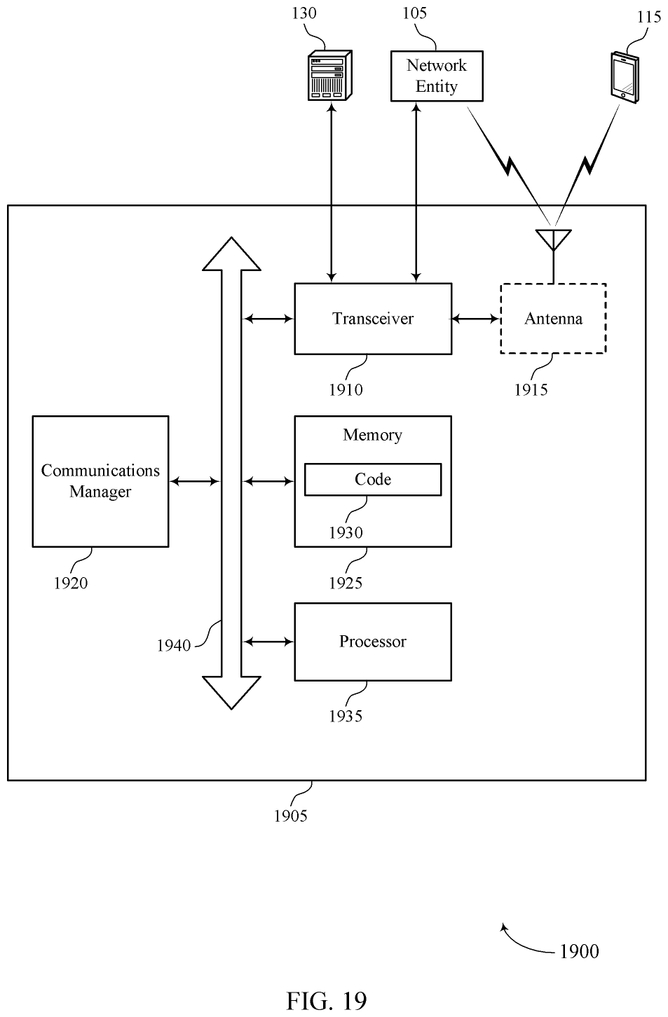

FIG. 19 shows a diagram of a system 1900 including a device 1905 that supports NZC selection and SCI for CJT CSI in accordance with one or more aspects of the present disclosure. The device 1905 may be an example of or include the components of a device 1605, a device 1705, or a network entity 105 as described herein. The device 1905 may communicate with one or more network entities 105, one or more UEs 115, or any combination thereof, which may include communications over one or more wired interfaces, over one or more wireless interfaces, or any combination thereof. The device 1905 may include components that support outputting and obtaining communications, such as a communications manager 1920, a transceiver 1910, an antenna 1915, a memory 1925, code 1930, and a processor 1935. These components may be in electronic communication or otherwise coupled (e.g., operatively, communicatively, functionally, electronically, electrically) via one or more buses (e.g., a bus 1940).

The transceiver 1910 may support bi-directional communications via wired links, wireless links, or both as described herein. In some examples, the transceiver 1910 may include a wired transceiver and may communicate bi-directionally with another wired transceiver. Additionally, or alternatively, in some examples, the transceiver 1910 may include a wireless transceiver and may communicate bi-directionally with another wireless transceiver. In some examples, the device 1905 may include one or more antennas 1915, which may be capable of transmitting or receiving wireless transmissions (e.g., concurrently). The transceiver 1910 may also include a modem to modulate signals, to provide the modulated signals for transmission (e.g., by one or more antennas 1915, by a wired transmitter), to receive modulated signals (e.g., from one or more antennas 1915, from a wired receiver), and to demodulate signals. In some implementations, the transceiver 1910 may include one or more interfaces, such as one or more interfaces coupled with the one or more antennas 1915 that are configured to support various receiving or obtaining operations, or one or more interfaces coupled with the one or more antennas 1915 that are configured to support various transmitting or outputting operations, or a combination thereof. In some implementations, the transceiver 1910 may include or be configured for coupling with one or more processors or memory components that are operable to perform or support operations based on received or obtained information or signals, or to generate information or other signals for transmission or other outputting, or any combination thereof. In some implementations, the transceiver 1910, or the transceiver 1910 and the one or more antennas 1915, or the transceiver 1910 and the one or more antennas 1915 and one or more processors or memory components (for example, the processor 1935, or the memory 1925, or both), may be included in a chip or chip assembly that is installed in the device 1905. In some examples, the transceiver may be operable to support communications via one or more communications links (e.g., a communication link 125, a backhaul communication link 120, a midhaul communication link 162, a fronthaul communication link 168).

The memory 1925 may include RAM and ROM. The memory 1925 may store computer-readable, computer-executable code 1930 including instructions that, when executed by the processor 1935, cause the device 1905 to perform various functions described herein. The code 1930 may be stored in a non-transitory computer-readable medium such as system memory or another type of memory. In some cases, the code 1930 may not be directly executable by the processor 1935 but may cause a computer (e.g., when compiled and executed) to perform functions described herein. In some cases, the memory 1925 may contain, among other things, a BIOS which may control basic hardware or software operation such as the interaction with peripheral components or devices.

The processor 1935 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1935 may be configured to operate a memory array using a memory controller. In some other cases, a memory controller may be integrated into the processor 1935. The processor 1935 may be configured to execute computer-readable instructions stored in a memory (e.g., the memory 1925) to cause the device 1905 to perform various functions (e.g., functions or tasks supporting NZC selection and SCI for CJT CSI). For example, the device 1905 or a component of the device 1905 may include a processor 1935 and memory 1925 coupled with the processor 1935, the processor 1935 and memory 1925 configured to perform various functions described herein. The processor 1935 may be an example of a cloud-computing platform (e.g., one or more physical nodes and supporting software such as operating systems, virtual machines, or container instances) that may host the functions (e.g., by executing code 1930) to perform the functions of the device 1905. The processor 1935 may be any one or more suitable processors capable of executing scripts or instructions of one or more software programs stored in the device 1905 (such as within the memory 1925). In some implementations, the processor 1935 may be a component of a processing system. A processing system may generally refer to a system or series of machines or components that receives inputs and processes the inputs to produce a set of outputs (which may be passed to other systems or components of, for example, the device 1905). For example, a processing system of the device 1905 may refer to a system including the various other components or subcomponents of the device 1905, such as the processor 1935, or the transceiver 1910, or the communications manager 1920, or other components or combinations of components of the device 1905. The processing system of the device 1905 may interface with other components of the device 1905, and may process information received from other components (such as inputs or signals) or output information to other components. For example, a chip or modem of the device 1905 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1905 may transmit information output from the chip or modem. Additionally, or alternatively, in some implementations, the one or more interfaces may refer to an interface between the processing system of the chip or modem and a receiver, such that the device 1905 may obtain information or signal inputs, and the information may be passed to the processing system. A person having ordinary skill in the art will readily recognize that a first interface also may obtain information or signal inputs, and a second interface also may output information or signal outputs.

In some examples, a bus 1940 may support communications of (e.g., within) a protocol layer of a protocol stack. In some examples, a bus 1940 may support communications associated with a logical channel of a protocol stack (e.g., between protocol layers of a protocol stack), which may include communications performed within a component of the device 1905, or between different components of the device 1905 that may be co-located or located in different locations (e.g., where the device 1905 may refer to a system in which one or more of the communications manager 1920, the transceiver 1910, the memory 1925, the code 1930, and the processor 1935 may be located in one of the different components or divided between different components).

In some examples, the communications manager 1920 may manage aspects of communications with a core network 130 (e.g., via one or more wired or wireless backhaul links). For example, the communications manager 1920 may manage the transfer of data communications for client devices, such as one or more UEs 115. In some examples, the communications manager 1920 may manage communications with other network entities 105, and may include a controller or scheduler for controlling communications with UEs 115 in cooperation with other network entities 105. In some examples, the communications manager 1920 may support an X2 interface within an LTE/LTE-A wireless communications network technology to provide communication between network entities 105.

The communications manager 1920 may support wireless communications at a network entity in accordance with examples as disclosed herein. For example, the communications manager 1920 may be configured as or otherwise support a means for transmitting, to a UE, control signaling indicating a multi-TRP configuration for the UE to use to communicate with the network entity via a first TRP and a second TRP associated with the network entity. The communications manager 1920 may be configured as or otherwise support a means for transmitting, via the first TRP and the second TRP, CSI-RSs according to the multi-TRP configuration. The communications manager 1920 may be configured as or otherwise support a means for receiving, from the UE and in response to the CSI-RSs, a UCI message including a NZC bitmap, where a size in quantity of bits of the NZC bitmap is based on a quantity of FD bases and a quantity of SD bases associated with the first TRP and the second TRP, where the FD bases associated with the first TRP at least partially overlap the FD bases associated with the second TRP.

By including or configuring the communications manager 1920 in accordance with examples as described herein, the device 1905 may support techniques for improved communication reliability, more efficient utilization of communication resources, improved coordination between devices, and improved utilization of processing capability.

In some examples, the communications manager 1920 may be configured to perform various operations (e.g., receiving, obtaining, monitoring, outputting, transmitting) using or otherwise in cooperation with the transceiver 1910, the one or more antennas 1915 (e.g., where applicable), or any combination thereof. For example, the communications manager 1920 may be configured to receive or transmit messages or other signaling as described herein via the transceiver 1910. Although the communications manager 1920 is illustrated as a separate component, in some examples, one or more functions described with reference to the communications manager 1920 may be supported by or performed by the transceiver 1910, the processor 1935, the memory 1925, the code 1930, or any combination thereof. For example, the code 1930 may include instructions executable by the processor 1935 to cause the device 1905 to perform various aspects of NZC selection and SCI for CJT CSI as described herein, or the processor 1935 and the memory 1925 may be otherwise configured to perform or support such operations.

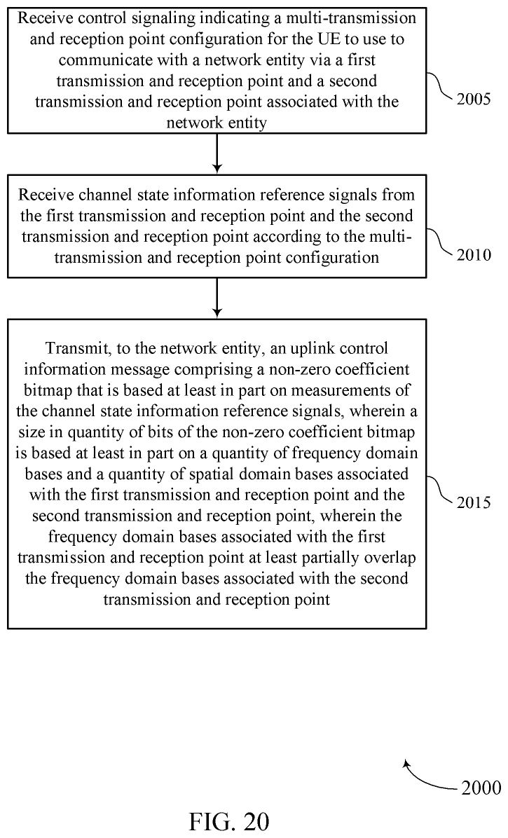

FIG. 20 shows a flowchart illustrating a method 2000 that supports NZC selection and SCI for CJT CSI in accordance with one or more aspects of the present disclosure. The operations of the method 2000 may be implemented by a UE or its components as described herein. For example, the operations of the method 2000 may be performed by a UE 115 as described with reference to FIGS. 1 through 15. In some examples, a UE may execute a set of instructions to control the functional elements of the UE to perform the described functions. Additionally, or alternatively, the UE may perform aspects of the described functions using special-purpose hardware.

At 2005, the method may include receiving control signaling indicating a multi-TRP configuration for the UE to use to communicate with a network entity via a first TRP and a second TRP associated with the network entity. The operations of 2005 may be performed in accordance with examples as disclosed herein. In some examples, aspects of the operations of 2005 may be performed by a multi TRP manager 1425 as described with reference to FIG. 14. Additionally, or alternatively, means for performing 2005 may, but not necessarily, include, for example, antenna 1525, transceiver 1515, communications manager 1520, memory 1530 (including code 1535), processor 1540 and/or bus 1545.

At 2010, the method may include receiving CSI-RSs from the first TRP and the second TRP according to the multi-TRP configuration. The operations of 2010 may be performed in accordance with examples as disclosed herein. In some examples, aspects of the operations of 2010 may be performed by a CSI-RS manager 1430 as described with reference to FIG. 14. Additionally, or alternatively, means for performing 2010 may, but not necessarily, include, for example, antenna 1525, transceiver 1515, communications manager 1520, memory 1530 (including code 1535), processor 1540 and/or bus 1545.

At 2015, the method may include transmitting, to the network entity, a UCI message including a NZC bitmap that is based on measurements of the CSI-RSs, where a size in quantity of bits of the NZC bitmap is based on a quantity of FD bases and a quantity of SD bases associated with the first TRP and the second TRP, where the FD bases associated with the first TRP at least partially overlap the FD bases associated with the second TRP. The operations of 2015 may be performed in accordance with examples as disclosed herein. In some examples, aspects of the operations of 2015 may be performed by an NZC bitmap manager 1435 as described with reference to FIG. 14. Additionally, or alternatively, means for performing 2015 may, but not necessarily, include, for example, antenna 1525, transceiver 1515, communications manager 1520, memory 1530 (including code 1535), processor 1540 and/or bus 1545.

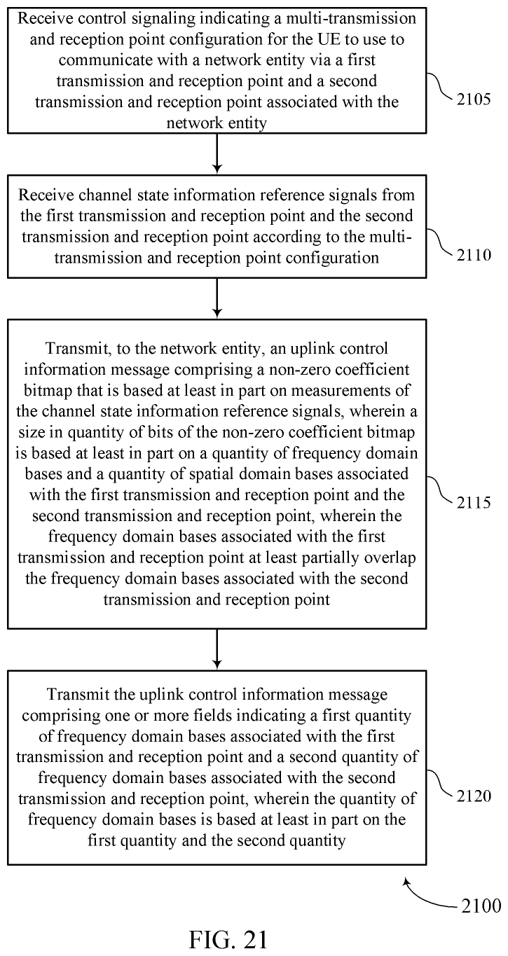

FIG. 21 shows a flowchart illustrating a method 2100 that supports NZC selection and SCI for CJT CSI in accordance with one or more aspects of the present disclosure. The operations of the method 2100 may be implemented by a UE or its components as described herein. For example, the operations of the method 2100 may be performed by a UE 115 as described with reference to FIGS. 1 through 15. In some examples, a UE may execute a set of instructions to control the functional elements of the UE to perform the described functions. Additionally, or alternatively, the UE may perform aspects of the described functions using special-purpose hardware.

At 2105, the method may include receiving control signaling indicating a multi-TRP configuration for the UE to use to communicate with a network entity via a first TRP and a second TRP associated with the network entity. The operations of 2105 may be performed in accordance with examples as disclosed herein. In some examples, aspects of the operations of 2105 may be performed by a multi TRP manager 1425 as described with reference to FIG. 14. Additionally, or alternatively, means for performing 2105 may, but not necessarily, include, for example, antenna 1525, transceiver 1515, communications manager 1520, memory 1530 (including code 1535), processor 1540 and/or bus 1545.

At 2110, the method may include receiving CSI-RSs from the first TRP and the second TRP according to the multi-TRP configuration. The operations of 2110 may be performed in accordance with examples as disclosed herein. In some examples, aspects of the operations of 2110 may be performed by a CSI-RS manager 1430 as described with reference to FIG. 14. Additionally, or alternatively, means for performing 2110 may, but not necessarily, include, for example, antenna 1525, transceiver 1515, communications manager 1520, memory 1530 (including code 1535), processor 1540 and/or bus 1545.

At 2115, the method may include transmitting, to the network entity, a UCI message including a NZC bitmap that is based on measurements of the CSI-RSs, where a size in quantity of bits of the NZC bitmap is based on a quantity of FD bases and a quantity of SD bases associated with the first TRP and the second TRP, where the FD bases associated with the first TRP at least partially overlap the FD bases associated with the second TRP. The operations of 2115 may be performed in accordance with examples as disclosed herein. In some examples, aspects of the operations of 2115 may be performed by an NZC bitmap manager 1435 as described with reference to FIG. 14. Additionally, or alternatively, means for performing 2115 may, but not necessarily, include, for example, antenna 1525, transceiver 1515, communications manager 1520, memory 1530 (including code 1535), processor 1540 and/or bus 1545.

At 2120, the method may include transmitting the UCI message including one or more fields indicating a first quantity of FD bases associated with the first TRP and a second quantity of FD bases associated with the second TRP, where the quantity of FD bases is based on the first quantity and the second quantity. The operations of 2120 may be performed in accordance with examples as disclosed herein. In some examples, aspects of the operations of 2120 may be performed by an FD bases manager 1440 as described with reference to FIG. 14. Additionally, or alternatively, means for performing 2120 may, but not necessarily, include, for example, antenna 1525, transceiver 1515, communications manager 1520, memory 1530 (including code 1535), processor 1540 and/or bus 1545.

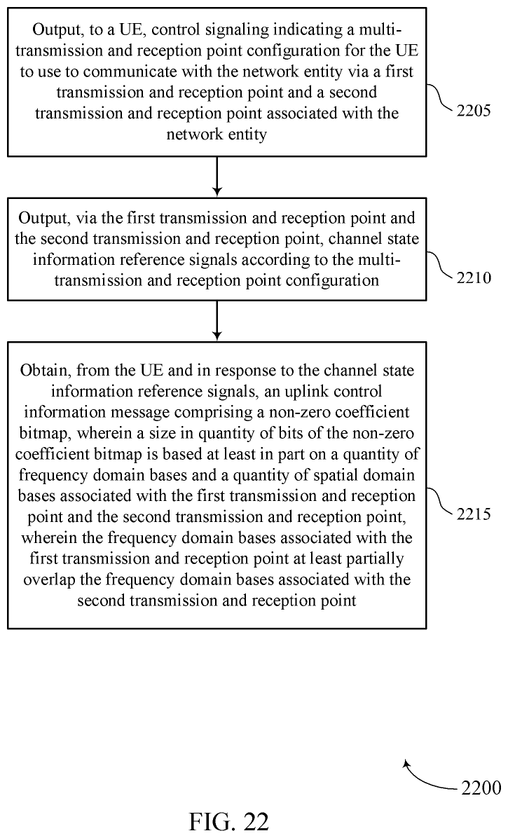

FIG. 22 shows a flowchart illustrating a method 2200 that supports NZC selection and SCI for CJT CSI in accordance with one or more aspects of the present disclosure. The operations of the method 2200 may be implemented by a network entity or its components as described herein. For example, the operations of the method 2200 may be performed by a network entity as described with reference to FIGS. 1 through 11 and 16 through 19. In some examples, a network entity may execute a set of instructions to control the functional elements of the network entity to perform the described functions. Additionally, or alternatively, the network entity may perform aspects of the described functions using special-purpose hardware.

At 2205, the method may include outputting, to a UE, control signaling indicating a multi-TRP configuration for the UE to use to communicate with the network entity via a first TRP and a second TRP associated with the network entity. The operations of 2205 may be performed in accordance with examples as disclosed herein. In some examples, aspects of the operations of 2205 may be performed by a multi TRP manager 1825 as described with reference to FIG. 18. Additionally, or alternatively, means for performing 2205 may, but not necessarily, include, for example, antenna 1915, transceiver 1910, communications manager 1920, memory 1925 (including code 1930), processor 1935 and/or bus 1940.

At 2210, the method may include outputting, via the first TRP and the second TRP, CSI-RSs according to the multi-TRP configuration. The operations of 2210 may be performed in accordance with examples as disclosed herein. In some examples, aspects of the operations of 2210 may be performed by a CSI-RS manager 1830 as described with reference to FIG. 18. Additionally, or alternatively, means for performing 2210 may, but not necessarily, include, for example, antenna 1915, transceiver 1910, communications manager 1920, memory 1925 (including code 1930), processor 1935 and/or bus 1940.

At 2215, the method may include obtaining, from the UE and in response to the CSI-RSs, a UCI message including a NZC bitmap, where a size in quantity of bits of the NZC bitmap is based on a quantity of FD bases and a quantity of SD bases associated with the first TRP and the second TRP, where the FD bases associated with the first TRP at least partially overlap the FD bases associated with the second TRP. The operations of 2215 may be performed in accordance with examples as disclosed herein. In some examples, aspects of the operations of 2215 may be performed by an NZC bitmap manager 1835 as described with reference to FIG. 18. Additionally, or alternatively, means for performing 2215 may, but not necessarily, include, for example, antenna 1915, transceiver 1910, communications manager 1920, memory 1925 (including code 1930), processor 1935 and/or bus 1940.

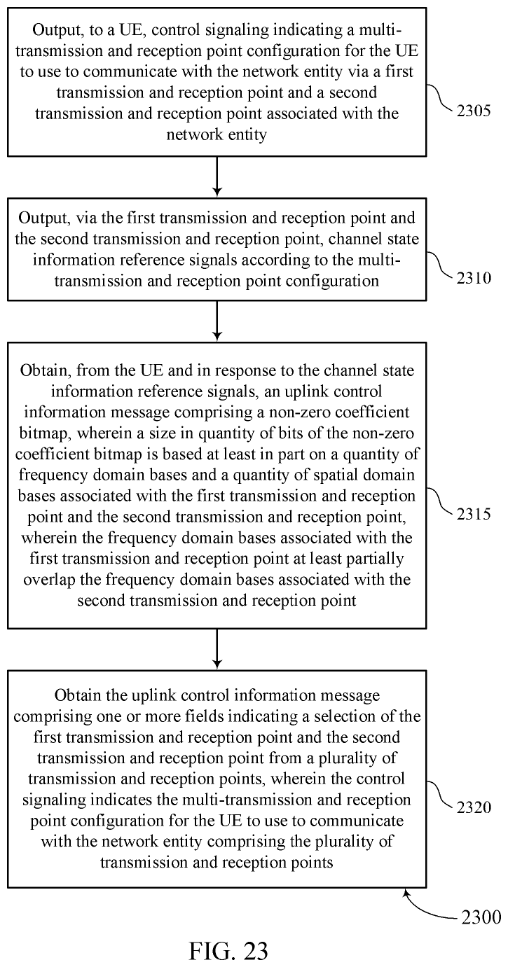

FIG. 23 shows a flowchart illustrating a method 2300 that supports NZC selection and SCI for CJT CSI in accordance with one or more aspects of the present disclosure. The operations of the method 2300 may be implemented by a network entity or its components as described herein. For example, the operations of the method 2300 may be performed by a network entity as described with reference to FIGS. 1 through 11 and 16 through 19. In some examples, a network entity may execute a set of instructions to control the functional elements of the network entity to perform the described functions. Additionally, or alternatively, the network entity may perform aspects of the described functions using special-purpose hardware.

At 2305, the method may include outputting, to a UE, control signaling indicating a multi-TRP configuration for the UE to use to communicate with the network entity via a first TRP and a second TRP associated with the network entity. The operations of 2305 may be performed in accordance with examples as disclosed herein. In some examples, aspects of the operations of 2305 may be performed by a multi TRP manager 1825 as described with reference to FIG. 18. Additionally, or alternatively, means for performing 2305 may, but not necessarily, include, for example, antenna 1915, transceiver 1910, communications manager 1920, memory 1925 (including code 1930), processor 1935 and/or bus 1940.

At 2310, the method may include outputting, via the first TRP and the second TRP, CSI-RSs according to the multi-TRP configuration. The operations of 2310 may be performed in accordance with examples as disclosed herein. In some examples, aspects of the operations of 2310 may be performed by a CSI-RS manager 1830 as described with reference to FIG. 18. Additionally, or alternatively, means for performing 2310 may, but not necessarily, include, for example, antenna 1915, transceiver 1910, communications manager 1920, memory 1925 (including code 1930), processor 1935 and/or bus 1940.

At 2315, the method may include obtaining, from the UE and in response to the CSI-RSs, a UCI message including a NZC bitmap, where a size in quantity of bits of the NZC bitmap is based on a quantity of FD bases and a quantity of SD bases associated with the first TRP and the second TRP, where the FD bases associated with the first TRP at least partially overlap the FD bases associated with the second TRP. The operations of 2315 may be performed in accordance with examples as disclosed herein. In some examples, aspects of the operations of 2315 may be performed by an NZC bitmap manager 1835 as described with reference to FIG. 18. Additionally, or alternatively, means for performing 2315 may, but not necessarily, include, for example, antenna 1915, transceiver 1910, communications manager 1920, memory 1925 (including code 1930), processor 1935 and/or bus 1940.

At 2320, the method may include obtaining the UCI message including one or more fields indicating a selection of the first TRP and the second TRP from a set of multiple TRPs, where the control signaling indicates the multi-TRP configuration for the UE to use to communicate with the network entity including the set of multiple TRPs. The operations of 2320 may be performed in accordance with examples as disclosed herein. In some examples, aspects of the operations of 2320 may be performed by an TRP selection manager 1840 as described with reference to FIG. 18. Additionally, or alternatively, means for performing 2320 may, but not necessarily, include, for example, antenna 1915, transceiver 1910, communications manager 1920, memory 1925 (including code 1930), processor 1935 and/or bus 1940.

The following provides an overview of aspects of the present disclosure:

Aspect 1: A method for wireless communications at a UE, comprising: receiving control signaling indicating a multi-TRP configuration for the UE to use to communicate with a network entity via a first TRP and a second TRP associated with the network entity; receiving CSI-RSs from the first TRP and the second TRP according to the multi-TRP configuration; and transmitting, to the network entity, an UCI message comprising a NZC bitmap that is based at least in part on measurements of the CSI-RSs, wherein a size in quantity of bits of the NZC bitmap is based at least in part on a quantity of FD bases and a quantity of SD bases associated with the first TRP and the second TRP, wherein the FD bases associated with the first TRP at least partially overlap the FD bases associated with the second TRP.

Aspect 2: The method of aspect 1, wherein transmitting the UCI message comprises: transmitting the UCI message comprising one or more fields indicating a first quantity of FD bases associated with the first TRP and a second quantity of FD bases associated with the second TRP, wherein the quantity of FD bases is based at least in part on the first quantity and the second quantity.

Aspect 3: The method of any of aspects 1 through 2, wherein transmitting the UCI message comprises: transmitting the UCI message comprising one or more fields indicating a selection of the first TRP and the second TRP from a plurality of TRPs, wherein the control signaling indicates the multi-TRP configuration for the UE to use to communicate with the network entity comprising the plurality of TRPs.

Aspect 4: The method of aspect 3, wherein a quantity of FD bases per TRP is inversely related to a quantity of TRPs selected in the UCI message.

Aspect 5: The method of any of aspects 1 through 4, wherein a quantity of FD bases per TRP is inversely related to a quantity of layers reported in the UCI message.

Aspect 6: The method of any of aspects 1 through 5, wherein transmitting the UCI message comprises: transmitting the UCI message comprising one or more fields indicating a first quantity of SD bases associated with the first TRP and a second quantity of SD bases associated with the second TRP, wherein the quantity of SD bases is based at least in part on the first quantity and the second quantity.

Aspect 7: The method of any of aspects 1 through 6, wherein receiving the control signaling comprises: receiving an indication of a first quantity of FD bases associated with the first TRP and a second quantity of FD bases associated with the second TRP, wherein the quantity of FD bases is based at least in part on the first quantity and the second quantity.

Aspect 8: The method of any of aspects 1 through 7, wherein receiving the control signaling comprises: receiving an indication of a first quantity of SD bases associated with the first TRP and a second quantity of SD bases associated with the second TRP, wherein the quantity of SD bases is based at least in part on the first quantity and the second quantity.

Aspect 9: The method of any of aspects 1 through 8, wherein transmitting the UCI message comprises: transmitting the UCI message comprising a set of fields indicating a layer-specific FD basis selection of a per-TRP basis.

Aspect 10: The method of aspect 9, wherein receiving the control signaling comprises: receiving the control signaling indicating the first TRP and the second TRP share a same layer-specific FD basis selection.

Aspect 11: The method of aspect 10, wherein transmitting the UCI message further comprises: transmitting a first delta amplitude associated with the first TRP and a second delta amplitude associated with the second TRP, wherein the first delta amplitude and the second delta amplitude are over a strongest coefficient.

Aspect 12: The method of any of aspects 1 through 11, wherein transmitting the UCI message comprises: transmitting the UCI message comprising a set of fields indicating a layer-common SD basis selection on a per TRP basis.

Aspect 13: The method of aspect 12, wherein receiving the control signaling comprises: receiving the control signaling indicating the first TRP and the second TRP share a same layer-common SD basis selection.

Aspect 14: The method of aspect 13, wherein a first quantity of FD bases associated with the first TRP is the same as a second quantity of FD bases associated with the second TRP.

Aspect 15: The method of any of aspects 13 through 14, wherein transmitting the UCI message further comprises: transmitting the UCI message comprising a field indicating a selection of one of the first TRP or the second TRP from a plurality of TRPs, wherein the control signaling indicates the multi-TRP configuration for the UE to use to communicate with the network entity comprising the plurality of TRPs, and wherein the selection of one of the first TRP or the second TRP comprises a selection of both the first TRP and the second TRP.

Aspect 16: The method of any of aspects 13 through 15, wherein transmitting the UCI message further comprises: transmitting a single delta amplitude associated with the first TRP and the second TRP, wherein the single delta amplitude is over a strongest coefficient.

Aspect 17: A method for wireless communications at a network entity, comprising: outputting, to a UE, control signaling indicating a multi-TRP configuration for the UE to use to communicate with the network entity via a first TRP and a second TRP associated with the network entity; outputting, via the first TRP and the second TRP, CSI-RSs according to the multi-TRP configuration; and obtaining, from the UE and in response to the CSI-RSs, an UCI message comprising a NZC bitmap, wherein a size in quantity of bits of the NZC bitmap is based at least in part on a quantity of FD bases and a quantity of SD bases associated with the first TRP and the second TRP, wherein the FD bases associated with the first TRP at least partially overlap the FD bases associated with the second TRP.

Aspect 18: The method of aspect 17, wherein obtaining the UCI message comprises: obtaining the UCI message comprising one or more fields indicating a selection of the first TRP and the second TRP from a plurality of TRPs, wherein the control signaling indicates the multi-TRP configuration for the UE to use to communicate with the network entity comprising the plurality of TRPs.

Aspect 19: The method of any of aspects 17 through 18, wherein a quantity of FD bases per TRP is inversely related to a quantity of layers reported in the UCI message.

Aspect 20: The method of any of aspects 17 through 19, wherein obtaining the UCI message comprises: obtaining the UCI message comprising one or more fields indicating a first quantity of SD bases associated with the first TRP and a second quantity of SD bases associated with the second TRP, wherein the quantity of SD bases is based at least in part on the first quantity and the second quantity.

Aspect 21: The method of any of aspects 17 through 20, wherein outputting the control signaling comprises: outputting an indication of a first quantity of FD bases associated with the first TRP and a second quantity of FD bases associated with the second TRP, wherein the quantity of FD bases is based at least in part on the first quantity and the second quantity.

Aspect 22: The method of any of aspects 17 through 21, wherein outputting the control signaling comprises: outputting an indication of a first quantity of SD bases associated with the first TRP and a second quantity of SD bases associated with the second TRP, wherein the quantity of FD bases is based at least in part on the first quantity and the second quantity.

Aspect 23: The method of any of aspects 17 through 22, wherein obtaining the UCI message comprises: obtaining the UCI message comprising a set of fields indicating a layer-specific FD basis selection of a per-TRP basis.

Aspect 24: The method of any of aspects 17 through 23, wherein outputting the UCI message comprises: outputting the UCI message comprising a set of fields indicating a layer-common SD basis selection on a per TRP basis.

Aspect 25: An apparatus comprising a memory, transceiver, and at least one processor coupled with the memory and the transceiver, the at least one processor configured to perform a method of any of aspects 1 through 16.

Aspect 26: An apparatus for wireless communications at a UE, comprising at least one means for performing a method of any of aspects 1 through 16.

Aspect 27: A non-transitory computer-readable medium storing code for wireless communications at a UE, the code comprising instructions executable by a processor to perform a method of any of aspects 1 through 16.

Aspect 28: An apparatus comprising a memory and at least one processor coupled with the memory, the at least one processor configured to perform a method of any of aspects 17 through 24.

Aspect 29: An apparatus for wireless communications at a network entity, comprising at least one means for performing a method of any of aspects 17 through 24.

Aspect 30: A non-transitory computer-readable medium storing code for wireless communications at a network entity, the code comprising instructions executable by a processor to perform a method of any of aspects 17 through 24.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or CAB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
receiving control signaling indicating a multi-transmission and reception point configuration for the UE to use to communicate with a network entity via a first transmission and reception point and a second transmission and reception point associated with the network entity;
receiving channel state information reference signals from the first transmission and reception point and the second transmission and reception point according to the multi-transmission and reception point configuration; and
transmitting, to the network entity, an uplink control information message comprising a non-zero coefficient bitmap that is based at least in part on measurements of the channel state information reference signals, wherein a size in quantity of bits of the non-zero coefficient bitmap is based at least in part on a quantity of frequency domain bases and a quantity of spatial domain bases associated with the first transmission and reception point and the second transmission and reception point, wherein the frequency domain bases associated with the first transmission and reception point at least partially overlap the frequency domain bases associated with the second transmission and reception point.

2. The method of claim 1, wherein transmitting the uplink control information message comprises:
transmitting the uplink control information message comprising one or more fields indicating a first quantity of frequency domain bases associated with the first transmission and reception point and a second quantity of frequency domain bases associated with the second transmission and reception point, wherein the quantity of frequency domain bases is based at least in part on the first quantity and the second quantity.

3. The method of claim 1, wherein transmitting the uplink control information message comprises:
transmitting the uplink control information message comprising one or more fields indicating a selection of the first transmission and reception point and the second transmission and reception point from a plurality of transmission and reception points, wherein the control signaling indicates the multi-transmission and reception point configuration for the UE to use to communicate with the network entity comprising the plurality of transmission and reception points.

4. The method of claim 3, wherein a quantity of frequency domain bases per transmission and reception point is inversely related to a quantity of transmission and reception points selected in the uplink control information message.

5. The method of claim 1, wherein a quantity of frequency domain bases per transmission and reception point is inversely related to a quantity of layers reported in the uplink control information message.

6. The method of claim 1, wherein transmitting the uplink control information message comprises:
transmitting the uplink control information message comprising one or more fields indicating a first quantity of spatial domain bases associated with the first transmission and reception point and a second quantity of spatial domain bases associated with the second transmission and reception point, wherein the quantity of spatial domain bases is based at least in part on the first quantity and the second quantity.

7. The method of claim 1, wherein receiving the control signaling comprises:
receiving an indication of a first quantity of frequency domain bases associated with the first transmission and reception point and a second quantity of frequency domain bases associated with the second transmission and reception point, wherein the quantity of frequency domain bases is based at least in part on the first quantity and the second quantity.

8. The method of claim 1, wherein receiving the control signaling comprises:
receiving an indication of a first quantity of spatial domain bases associated with the first transmission and reception point and a second quantity of spatial domain bases associated with the second transmission and reception point, wherein the quantity of spatial domain bases is based at least in part on the first quantity and the second quantity.

9. The method of claim 1, wherein transmitting the uplink control information message comprises:
transmitting the uplink control information message comprising a set of fields indicating a layer-specific frequency domain basis selection of a per-transmission and reception point basis.

10. The method of claim 9, wherein receiving the control signaling comprises:
receiving the control signaling indicating the first transmission and reception point and the second transmission and reception point share a same layer-specific frequency domain basis selection.

11. The method of claim 10, wherein transmitting the uplink control information message further comprises:
transmitting a first delta amplitude associated with the first transmission and reception point and a second delta amplitude associated with the second transmission and reception point, wherein the first delta amplitude and the second delta amplitude are over a strongest coefficient.

12. The method of claim 1, wherein transmitting the uplink control information message comprises:
transmitting the uplink control information message comprising a set of fields indicating a layer-common spatial domain basis selection on a per transmission and reception point basis.

13. The method of claim 12, wherein receiving the control signaling comprises:
receiving the control signaling indicating the first transmission and reception point and the second transmission and reception point share a same layer-common spatial domain basis selection.

14. The method of claim 13, wherein a first quantity of frequency domain bases associated with the first transmission and reception point is the same as a second quantity of frequency domain bases associated with the second transmission and reception point.

15. The method of claim 13, wherein transmitting the uplink control information message further comprises:
transmitting the uplink control information message comprising a field indicating a selection of one of the first transmission and reception point or the second transmission and reception point from a plurality of transmission and reception points, wherein the control signaling indicates the multi-transmission and reception point configuration for the UE to use to communicate with the network entity comprising the plurality of transmission and reception points, and wherein the selection of one of the first transmission and reception point or the second transmission and reception point comprises a selection of both the first transmission and reception point and the second transmission and reception point.

16. The method of claim 13, wherein transmitting the uplink control information message further comprises:
transmitting a single delta amplitude associated with the first transmission and reception point and the second transmission and reception point, wherein the single delta amplitude is over a strongest coefficient.

17. A method for wireless communications at a network entity, comprising:
outputting, to a user equipment (UE), control signaling indicating a multi-transmission and reception point configuration for the UE to use to communicate with the network entity via a first transmission and reception point and a second transmission and reception point associated with the network entity;
outputting, via the first transmission and reception point and the second transmission and reception point, channel state information reference signals according to the multi-transmission and reception point configuration; and
obtaining, from the UE and in response to the channel state information reference signals, an uplink control information message comprising a non-zero coefficient bitmap, wherein a size in quantity of bits of the non-zero coefficient bitmap is based at least in part on a quantity of frequency domain bases and a quantity of spatial domain bases associated with the first transmission and reception point and the second transmission and reception point, wherein the frequency domain bases associated with the first transmission and reception point at least partially overlap the frequency domain bases associated with the second transmission and reception point.

18. The method of claim 17, wherein obtaining the uplink control information message comprises:
obtaining the uplink control information message comprising one or more fields indicating a selection of the first transmission and reception point and the second transmission and reception point from a plurality of transmission and reception points, wherein the control signaling indicates the multi-transmission and reception point configuration for the UE to use to communicate with the network entity comprising the plurality of transmission and reception points.

19. The method of claim 17, wherein a quantity of frequency domain bases per transmission and reception point is inversely related to a quantity of layers reported in the uplink control information message.

20. The method of claim 17, wherein obtaining the uplink control information message comprises:
obtaining the uplink control information message comprising one or more fields indicating a first quantity of spatial domain bases associated with the first transmission and reception point and a second quantity of spatial domain bases associated with the second transmission and reception point, wherein the quantity of spatial domain bases is based at least in part on the first quantity and the second quantity.

21. The method of claim 17, wherein outputting the control signaling comprises:
outputting an indication of a first quantity of frequency domain bases associated with the first transmission and reception point and a second quantity of frequency domain bases associated with the second transmission and reception point, wherein the quantity of frequency domain bases is based at least in part on the first quantity and the second quantity.

22. The method of claim 17, wherein outputting the control signaling comprises:
outputting an indication of a first quantity of spatial domain bases associated with the first transmission and reception point and a second quantity of spatial domain bases associated with the second transmission and reception point, wherein the quantity of frequency domain bases is based at least in part on the first quantity and the second quantity.

23. The method of claim 17, wherein obtaining the uplink control information message comprises:
obtaining the uplink control information message comprising a set of fields indicating a layer-specific frequency domain basis selection of a per-transmission and reception point basis.

24. The method of claim 17, wherein outputting the uplink control information message comprises:
outputting the uplink control information message comprising a set of fields indicating a layer-common spatial domain basis selection on a per transmission and reception point basis.

25. An apparatus for wireless communications comprising:
memory;
a transceiver; and
at least one processor of a user equipment (UE), the at least one processor coupled with the memory and the transceiver, and the at least one processor configured to:
receive, via the transceiver, control signaling indicating a multi-transmission and reception point configuration for the UE to use to communicate with a network entity via a first transmission and reception point and a second transmission and reception point associated with the network entity;
receive, via the transceiver, channel state information reference signals from the first transmission and reception point and the second transmission and reception point according to the multi-transmission and reception point configuration; and
transmit, to the network entity and via the transceiver, an uplink control information message comprising a non-zero coefficient bitmap that is based at least in part on measurements of the channel state information reference signals, wherein a size in quantity of bits of the non-zero coefficient bitmap is based at least in part on a quantity of frequency domain bases and a quantity of spatial domain bases associated with the first transmission and reception point and the second transmission and reception point, wherein the frequency domain bases associated with the first transmission and reception point at least partially overlap the frequency domain bases associated with the second transmission and reception point.

26. The apparatus of claim 25, the at least one processor further configured to:
transmit, via the transceiver, the uplink control information message comprising one or more fields indicating a first quantity of frequency domain bases associated with the first transmission and reception point and a second quantity of frequency domain bases associated with the second transmission and reception point, wherein the quantity of frequency domain bases is based at least in part on the first quantity and the second quantity.

27. The apparatus of claim 25, wherein to transmit the uplink control information message, the at least one processor is further configured to:
transmit, via the transceiver, the uplink control information message comprising one or more fields indicating a selection of the first transmission and reception point and the second transmission and reception point from a plurality of transmission and reception points, wherein the control signaling indicates the multi-transmission and reception point configuration for the UE to use to communicate with the network entity comprising the plurality of transmission and reception points.

28. The apparatus of claim 27, wherein a quantity of frequency domain bases per transmission and reception point is inversely related to a quantity of transmission and reception points selected in the uplink control information message.

29. The apparatus of claim 25, wherein a quantity of frequency domain bases per transmission and reception point is inversely related to a quantity of layers reported in the uplink control information message.

30. An apparatus for wireless communications comprising:
memory; and
at least one processor of a network entity, the at least one processor coupled with the memory, and the at least one processor configured to:
output, to a user equipment (UE), control signaling indicating a multi-transmission and reception point configuration for the UE to use to communicate with the network entity via a first transmission and reception point and a second transmission and reception point associated with the network entity;
output, via the first transmission and reception point and the second transmission and reception point, channel state information reference signals according to the multi-transmission and reception point configuration; and
obtain, from the UE and in response to the channel state information reference signals, an uplink control information message comprising a non-zero coefficient bitmap, wherein a size in quantity of bits of the non-zero coefficient bitmap is based at least in part on a quantity of frequency domain bases and a quantity of spatial domain bases associated with the first transmission and reception point and the second transmission and reception point, wherein the frequency domain bases associated with the first transmission and reception point at least partially overlap the frequency domain bases associated with the second transmission and reception point.
